(19) United States
(12) Patent Application Publication
(10) Pub. No.: US 2014/0156582 A1
(43) Pub. Date: Jun. 5, 2014

(54) Item Response Methods as Applied to a Dynamic Content Distribution System and Methods

(71) Applicant: Jayson Holliewood Cornelius, Oviedo, FL (US)

(72) Inventor: Jayson Holliewood Cornelius, Oviedo, FL (US)

(21) Appl. No.: 13/691,698

(22) Filed: Nov. 30, 2012

(51) Int. Cl. G06N 5/04

(52) U.S. Cl. CPC G06N 5/04
USPC 706/50

(57) ABSTRACT

The present invention relates generally to a dynamic content distribution system, and more particularly, relates to usage of Item Response Methods as applied to a dynamic content distribution system and method that uses the Item Response Methods of various Item Response Functions (IRF) to provide digital content to end-users based on psychometric reasoning. More specifically, the instant invention gathers psychometric attributes of Registered Users and combines those psychometric attributes with Item Response Function methods to determine how and when digital content is presents to Registered Users.

This application is a Continuation-in-Part of patent application Ser. No. 12/907,020, filed Oct. 18, 2010.

### FIELD OF THE INVENTION

The present invention relates generally to a dynamic content distribution system, and more particularly, relates to usage of Item Response Methods as applied to a dynamic content distribution system and method that uses the Item Response Methods of various Item Response Functions (IRF) to provide digital content to end-users based on psychometric reasoning. More specifically, the instant invention gathers psychometric attributes of Registered Users and combines those psychometric attributes with Item Response Function methods to determine how and when digital content is presents to Registered Users.

### BACKGROUND OF THE INVENTION

When users access the Internet, they use web browsers such as Microsoft Explorer, Mozilla, Firefox, or Google Chrome, among others. Usually the first page displayed when the web browser is started is called a home page. Users can designate any website as a home page, but typically Internet users, use search engine enabled websites for their home page such as “MSN.COM”, “AOL.COM”, and “GOOGLE.COM”. Typically, these types of home pages have dynamic content feeds from several content providers and they feature advertisements from local or national advertisers. In most causes, the content that is featured on the home pages changes at some random interval to provide users with a variety of content from a variety of sources.

Entertainment related websites such as “MTV.COM”, “BET.COM” and EntertainmentWeekly.com display entertainment related content, and display some form of advertisement. In over 90% of the websites listed on “PC Magazine's Top 100 Websites List” most have dynamic content and advertisements from internal and third party sources. Further, websites generally provide users with content pertaining to a wide array of subjects and these websites feature some form of advertisement. It is typical to see commercial videos, banners, sponsored links and advertisements from internet advertising sources like Google, Yahoo, and Bing, etc. featured on websites through out the internet.

Psychometrics is the field of study concerned with the theory and technique of educational and psychological measurement, which includes the measurement of knowledge, abilities, attitudes, and personality traits. The field is primarily concerned with the construction and validation of measurement instruments, such as questionnaires, tests, and personality assessments. It involves two major research tasks, namely: (i) the construction of instruments and procedures for measurement; and (ii) the development and refinement of theoretical approaches to measurement. The instant invention gathers psychometric attributes of Registered Users and combines those psychometric attributes with Item Response Function methods to determine how and when digital content is presents to Registered Users.

It would be desirable for websites to have an automatic content distribution system that use Item Response Functions (IRF) to measure Registered User's reactions to content that is suggested based on the Registered User's psychometric reasoning abilities.

It would also be desirable for advertisers and content providers to have an automatic content distribution system that use Item Response Functions (IRF) to measure end-user reactions to content that is suggested based on the Registered User's psychometric reasoning abilities.

It would also be desirable for affiliates that endorse content and advertisement to have an automatic content distribution system that use Item Response Functions (IRF) to measure the end-user reactions to the content that is suggested based on the Registered User's psychometric reasoning abilities.

It would be desirable for software application developers to have an automatic content distribution system that use Item Response Functions (IRF) to measure end-user reactions to content that is suggested based on the Registered User's psychometric reasoning abilities.

It would be desirable for end-user's to have digital content, advertisements and software solutions suggested to them based on their individualized psychometric attributes and reasoning abilities. In addition, the system may track the Registered User's attributes and provide feedback.

The present invention addresses these needs by providing a dynamic content distribution system that uses a unique Item Response Function (IRF) method to provide digital content to end-users based on psychometric reasoning.

### BRIEF DESCRIPTION OF THE DRAWINGS

FIG. 1 presents an overview of the linkage between the Dynamic Content and the Item Response Function.

FIG. 1A presents the initial installation usage process flowchart.

FIG. 1B presents an expanded user item response tracking flowchart.

FIG. 1C presents an expanded user item response polling flowchart.

FIG. 2 presents the updating of the User RDMS due to processing of a user response.

FIG. 3 presents the combination of various response functions to form an ability estimation.

FIG. 4 presents a general model response function equation and exemplary variables.

FIG. 5 presents a model response function equation and exemplary variables particularly applicable to test information.

FIG. 6 presents a model response function equation and exemplary variables particularly applicable to poll users via presenting information and tracking responses.

FIG. 7 presents a model response function equation and exemplary variables particularly applicable to suggest content to the user.

FIG. 8 presents a model response function equation and exemplary variables particularly applicable to suggest content to the user based on the ability estimation.

FIG. 9 presents a diagram of a simplified User Interface.

FIG. 10 presents exemplary tables of tabular data.

FIG. 11 presents exemplary tables of repository data.

FIG. 12 presents exemplary tables of indexed data linked to content location, exemplary item response function polling, and PIRI INTELLIGENT API processing.

FIG. 13 presents exemplary tables of indexed data linked to content location, exemplary item response function polling, and PIRI INTELLIGENT API processing.

FIG. 14 presents exemplary tables of indexed data linked to content location, exemplary item response function polling, and PIRI INTELLIGENT API processing.

FIG. 16 presents exemplary tables of indexed data linked to content location, exemplary item response function polling, and PIRI INTELLIGENT API processing.

FIG. 18 presents exemplary tables of indexed data linked to content location, exemplary item response function polling, and PIRI INTELLIGENT API processing.

FIG. 19 presents exemplary tables of indexed data linked to content location, exemplary item response function polling, and PIRI INTELLIGENT API processing.

FIG. 20 presents exemplary tables of indexed data linked to content location, exemplary item response function polling, and PIRI INTELLIGENT API processing.

### SUMMARY OF THE INVENTION

One embodiment of the present invention is an Internet Web Browser Plug-in application that use Cloud Computing Applications and Item Response Functions (IRF) to suggest specific content to Internet Users based on their Psychometric Reasoning Abilities. The content is suggested in the following manner: The Registered User completes a registration survey, the user answers to the survey is scored and the results are stored in the Registered User's profile, the survey scores and other information contained in the Registered User's profile is used to suggest Internet Content that is relevant to the Registered User's psychometric attributes based at least in part on an Alpha-Numeric Identification Sequential Score (AIS Score or AISS).

During registration of the Plug-in Application Registered Users are required to complete a dynamic series of psychometric questions. The answers to the questions are scored using a specially created answer key that use Item Response Functions (IRF) to identify the Registered User's personality, interests, aptitude, and abilities. After completing the questions; before the application is fully rendered, the Registered User is provided with personalized content choices that matches the Registered User's psychometric attributes. After the Registered User selects the recommended content, the homepage is created and populated with the individualized content and the installation is completed.

The Registered User psychometric attributes are stored in the Registered Users Database and an identification code called an Alpha-Numeric Identification Sequential Score (AIS Score or AISS) is created for each Registered User. The Registered User's AIS Score data is accessed, stored and processed by a Relational Database Management System (RDBMS). A processing application called the PIRI INTELLIGENT API monitors the Registered User's AIS Score data and the Registered User's actions to the content that is suggested. The PIRI INTELLIGENT API uses an algorithm derived from Item Response Function (IRF) equation to process the interactions of the User Psychometrical AIS Score with MetaData Elements called MetaDerms(s).

A MetaDerm is a specially derived identification code used, by the PIRI INTELLIGENT API to suggest content that is relevant to the end users Psychometric Attributes. The System uses two types of MetaDerms. Subscriber Assigned MetaDerms (SAM) which are dynamic with reciprocal features and Content Assigned MetaDerms (CAM) which are transient with compensating features.

Registration is required to become a Registered SAM Affiliate (also referred to herein as a SAM User) and receive a SAM AIS Score. SAM Users are required to complete a registration form that has static series of psychometric questions and additional information about the SAM User's target market attributes. The answers to the questions are scored using a specially created Answer Key Database that is used to identify which Register User's match the types of personalities, interests, aptitudes, and abilities that the Subscriber compliments. After completing the registration, a SAM AIS Score is created and the number is registered with the local SAM MetaData Registry and/or to a remote MetaData Registry.

Registration is required to receive a CAM AIS Score. CAM Users are required to complete a static series of psychometric questions. The answers to the questions are scored using a specially created Answer Key Database that is used to identify which Register User's match the types of personalities, interests, aptitudes, and abilities that the Content compliments. After completing the registration, a CAM AIS Score is created and the number is registered with a local CAM MetaData Registry and/or to a remote MetaData Registry.

The PIRI INTELLIGENT API Processes the Personality AIS Score, the SAM AIS Score and CAM AIS Score and use the data from of the respecting MetaData Registries to determine how content is displayed; to whom the content is displayed; what type of content that is displayed; when and why particular content is displayed.

Additional embodiment of the present invention, which is an automatic Content Distribution System maybe registered and used with third parties such as cloud applications, applications made by third parties using the PIRI Intelligent API, search engines such as Yahoo, Bing, and Google, and alternative browser in addition to Microsoft Explorer, such as Firefox, Safari and Google Chrome.

The Web Browser Plug-in Application is platform independent and may be installed on any Web Browser Application that allow plug-ins. Typically, Web Browser Plug-in's are programmed using the Application Programming Interface (API) provided by the developer of the Web Browser. In particular the Plug-In Application is programmed to send and receive MetaData information from remote MetaData Registries (such as a SAM MetaData Registry or a CAM MetaData Registry). The MetaData Registry stores the definitions of the MetaData that the Web Plug-in use to determine how content is displayed; to whom the content is displayed; what type of content that is displayed; when and why particular content is displayed.

The application may be installed on any Computer Enabled Device that access the internet using Internet Browsers; these may include Wireless Smart Phones, Ultra Mobile Personal Computers (UMPC), Smart Residential Phones, Digital Cable Boxes, IPTV Appliances, Handheld Devices, Personal & Notebook Computers, Satellite Radio devices, Home Automation devices, just to name a few.

The Web Browser Plug-in may be installed as a Plug-In Application using a set of software components in compliance with the Web Browser (API) standards. Further, using the methods explained in the this patent, the Plug-in Application may also be developed as an independent software application. The Web Browser Plug-in Application may be installed using an online repository that allows Registered Users to download and install the software Plug-in Application or by using media such as CDROM, DVDROM, USB Drives, and similar storage collectively referred to as Media.

### DETAILED DESCRIPTION

Dynamic Content Distribution is linked to the user's Content Management System using Location Tags which are linked to SAM Tags which are themselves linked to CAM Tags which are linked to and processed by: 1) Item Response Function operators [which apply response function models such as the 3 Parameter Logistics Model (3PL IRF)], and 2) a PIRI SUGGESTIVE Operator [a processing script or Application Programming Interface (API)], where the PIRI SUGGESTIVE operator posts statistics and/or results to a widget (such as a display output element including an independent application window or box which coexists with other applications and the operating system) that displays the statistics/or results on a User Profile page.

The present invention presents a dynamic content distribution method wherein an item response function (IRF) is used to suggest content to end-users based on psychometric reasoning; wherein the content is provided by a relational database management system which stores content and the content is categorized according to psychometric attributes according to predetermined psychological measurement categories; wherein the categories include the measure of knowledge, abilities, attitudes, and personality traits; wherein the content suggested relates to a topic selected from the group including (news, entertainment, entertainment, money and finance, lifestyle, music, movies, local and regional events and information, and education, and wherein the IRF is used to measure and deliver content based on the user's traits selected from the group consisting of Personality Attributes, Abstract Reasoning Attributes, Numerical Reasoning Attributes, Verbal Reasoning Attributes, Computer Skill Set Attributes, Emotional Quotient Attributes, Mechanical Reasoning Attributes, Cognitive Reasoning Attributes, Intelligent Quotient Attributes, and Spatial Ability Attributes as well as to deliver content based on a comparison to the Personality Attributes of other users.

Further, the item response function (IRF) as disclosed and used herein may be used to suggest content from cloud applications.

Still further the item response function (IRF) as disclosed and used herein may selected from a group of functions including: a test information function (TIF), an item information function (IIF), a standard error management function (SEM), and an ability estimation model function (AEM).

The item response function (IRF) as disclosed and used herein may be used in any combination which inter-relates the selection of the preceding groups of functions, traits, and topics.

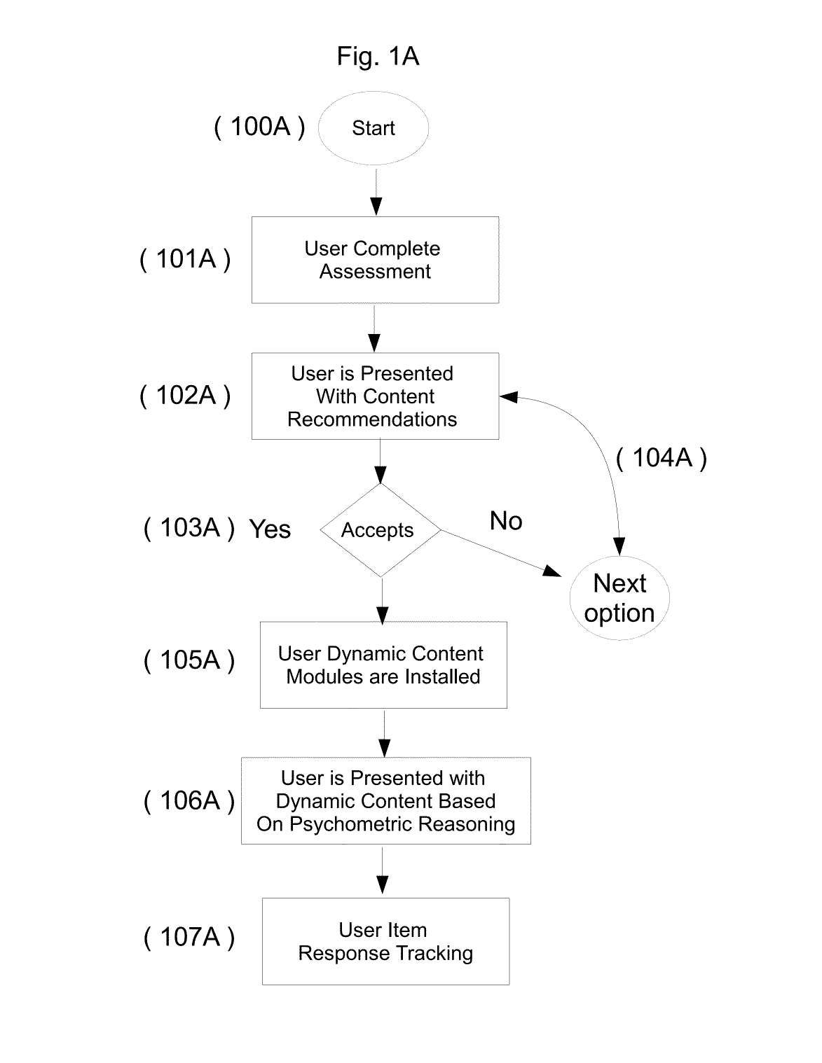

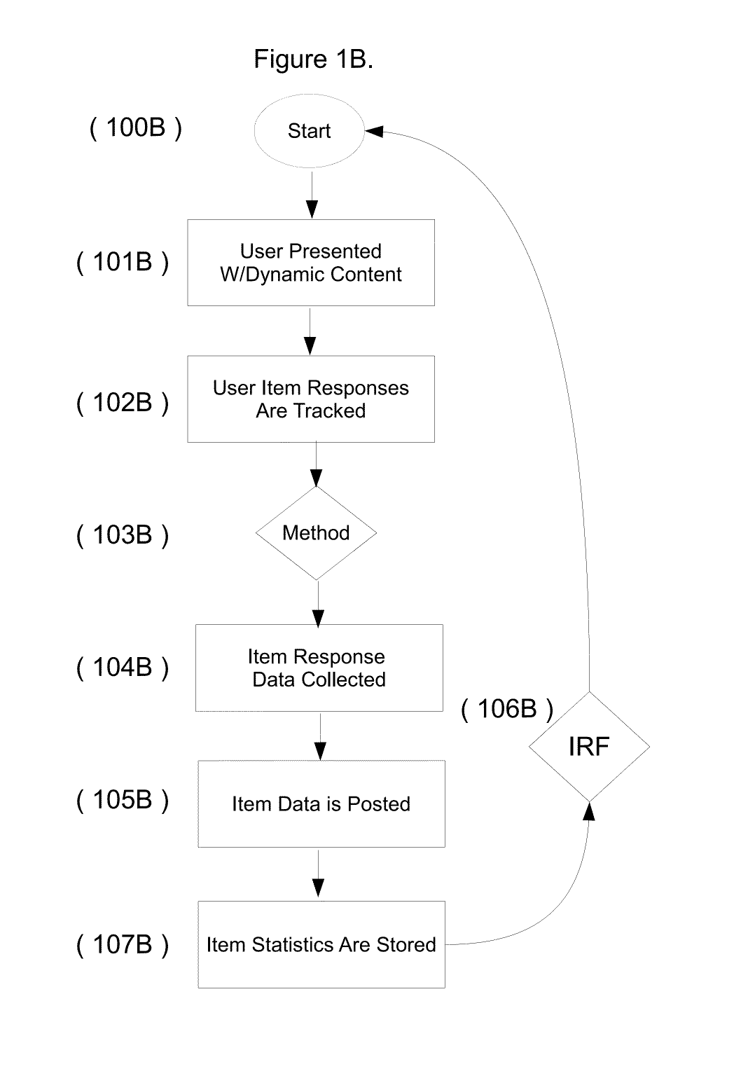

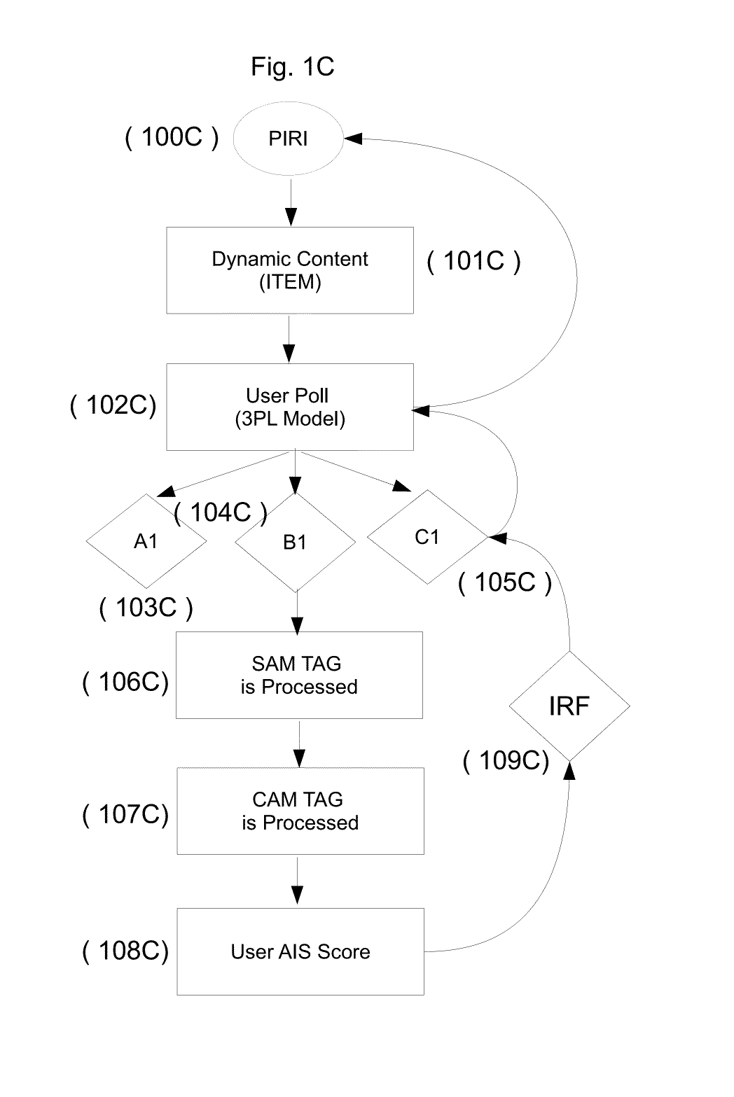

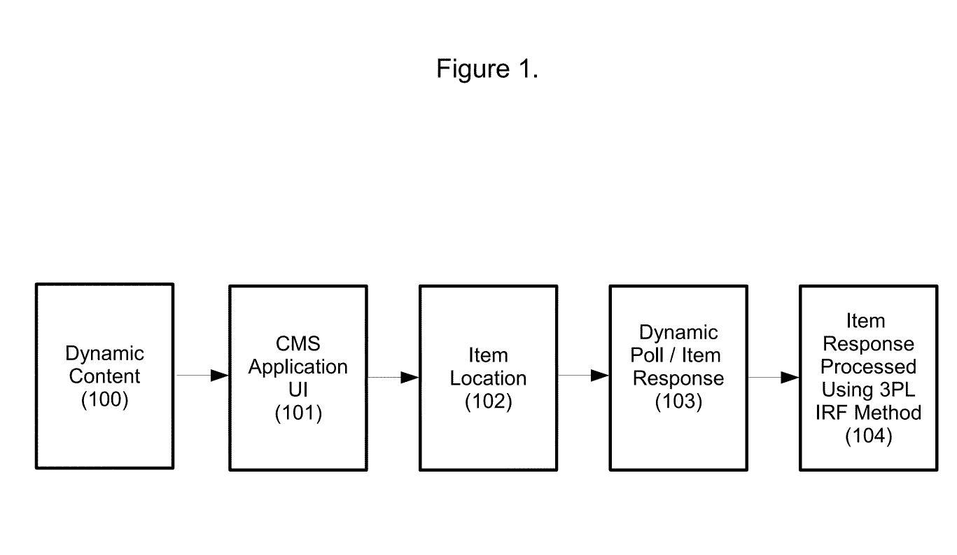

As FIG. 1A indicates when the User start (100A) the installation process it is required that the User complete a series of psychometric assessments (101A). At this time, when the installation method for Dynamic Content Distribution is initiated, the User is presented with content recommendations (102A) which the User may accept (103A) or decline (104A).

If the User accepts the recommended content, the selected User Dynamic Content Modules are installed (105A). During normal use the present invention is intended to function in a manner using methods explained herein wherein Dynamic Content Distribution is present to the User based on Psychometric Reasoning (106A) and the Item Response Function Model Equations are used to provide Algorithms and Logarithms to track User Item Responses (107A).

As step (104A) indicates when the User selects “No” to the present content recommendations during installation the user is presented with the next option (next content recommendation).

FIG. 1B expands the User Item Response Tracking (107A) featured on FIG. 1A. The expanded functions start (100B) assuming the following steps for Item Response Tracking using Item Response Theory and is applicable to the following Item Response Models: the general 3PL Item Response Function (300), the Test Response Function (301), the Test Information Function (302), the Likelihood Function (303), the Standard Error Measurement Function (304), and the Ability Estimation Function (305). When these individual functions are processed by the PIRI SUGGESTIVE API as the Dynamic Content Distribution explanation describes, the individual function is generically referred to as a Method (103B).

PIRI Intelligent Application Programming Interface (API)

As disclosed in patent application Ser. No. 12/907,020, the PIRI INTELLIGENT API (108,115, 125) connects to multiple databases, handle errors, and process data requests, execute SQL commands, bind input parameters, execute queries and fetch result sets. The PIRI INTELLIGENT API also allows the binding of LongBinary, LongChar, BLob and CLob data, as well as the Fetching of LongBinary, LongChar, BLob and CLob data and enables Multithreading support and canceling queries.

The PIRI INTELLIGENT API uses a C# language library to process data and information that the Present Invention relies upon. The PIRI INTELLIGENT API acts as middleware and provides database portability which allows developers and persons skilled in the art to create scripts that processes the data contained in the databases explained in this application using programming languages that is native to Oracle Database Server, Microsoft SQL Server, Sybase, DB2, Informix, InterBase/Firebird, Centura, MySQL, PostgreSQL, ODBC, SQLite.

The PIRI INTELLIGENT API contains a library of algorithms that use Item Response Functions to monitor, track, process, and suggest content to users as well as provide content suggestions regarding the specific nature of content that is targeted to users. The programming contained in this explanation can be achieved using the PIRI INTELLIGENT API to process SQL Queries and Statements within each respective Relational Database Management System (RDMS).

For the sake of explanation, and open connectivity of the Databases, the features, processes, routines, functions and sub-functions, as well as queries, statements and other methods and processes are programmed using scripts contained within the PIRI INTELLIGENT API. A person skilled in the art would be able to use the PIRI INTELLIGENT API to program the unique operations and novel methods of the instant invention using C# language to implement database queries. Note—while the programming skill required is within the skill of a person of ordinary skill in the art, the present invention presents unique operations and novel non-obvious methods for dynamic content distribution.

In the present application, as shown in FIG. 1B, at Start (100B) the User is presented with dynamic content (101B) and during system usage when the user clicks the content (such as by selecting a category, a link, a page, a video, or any digital content that is presented to execute, open, view or be watched) every user interaction with the content is tracked by special Locations Tags as well SAM and CAM Tags as explained in the Dynamic Content Distribution Method of patent application Ser. No. 12/907,020. Collectively the user interactions are called Item Responses. User Item Responses are tracked (102B) and processed using Item Response Functions and Methods (103B) and the Item Response Data is collected (104B) and Item Data is Posted to the User's Profile and Relational Database Management Systems and the Item Statistics are stored (107B) wherein this process is completed in conjunction with each Item Response Function (106B) such as after each Item Response Function (106B).

FIG. 1C expands on the User's Item Response when a poll is used. Please note that content clicks and interaction are processed using the PIRI INTELLIGENT API (100C) and Dynamic Content (101C) and Item Responses are collected from the User Interactions two ways. Method: 1) the User Item Response is tracked via the user's clicks and interactions with the content, and Method: 2) the user Item Response is tracked with Polls, Questions and Surveys.

In Method 1 where the Item Response Functions are used to track the user's clicks and interactions, parameters are hidden from the user and encoded into the dynamic content Location Tags. In Method 2, as (102C) depicts, Users are presented with a Poll, Question, Rating, or Scale. Both Method 1 and Method 2 use parameters A1, (103C) B1, (104C) C1, (105C) which in Item Response Theory are referred to as the parameters of the 3 Parameter Logistics Model (or 3PL IRF).

After the User makes a selection one or more Item Response Functions (109C) are used to processed the data and the PIRI INTELLIGENT API uses the data to process the SAM TAG (106C), CAM TAG (107C) and User's AIS Score (108C).

The following explanation of methods and functions explains this process as it relates to use Item Response Functions based on Item Response Theory to track, monitor and store Item Response Function (300), Test Response Function (301), Test Information Function (302), Likelihood Function (303), Standard Error Measurement Function (304) and the Ability Estimation Function (305), collectively referred to as Item Response Functions.

In the present invention, the Dynamic Content Distribution Application, suggests dynamic content (100) to Users via the User's Content Management System, the Application User Interface (101), and the Item Location (102)—which are coordinated to specify what, where and how the dynamic content is presented. When the User reviews the content that is presented, the User is presented with a Dynamic Poll (103), when a user responds it is called an Item Response (103). After this polling process, a processing of the User's item response is processed (104) using a 3PL IRF Algorithm.

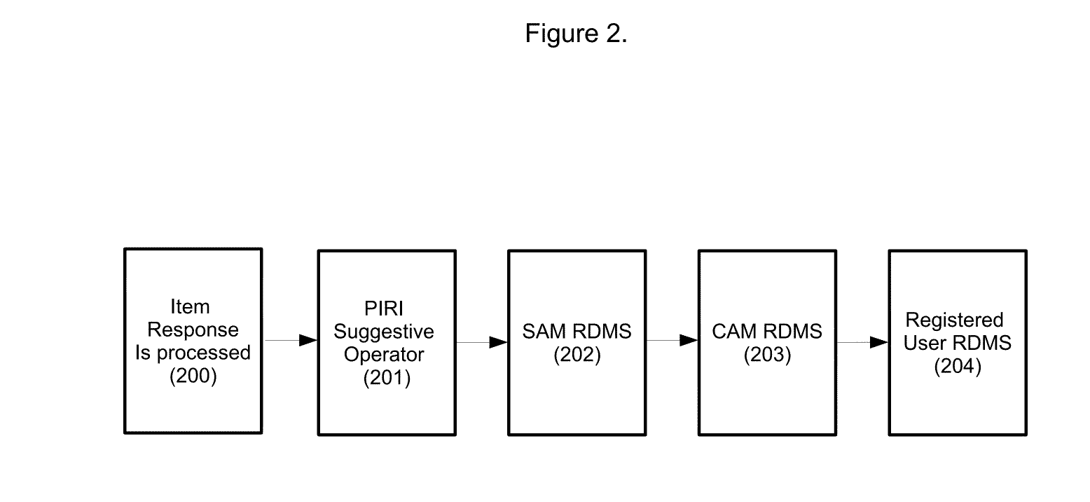

As shown in FIG. 2, once the Item Response is processed (200), the data is used by the PIRI INTELLIGENT API (201), and then compared to the SAM RDMS (202) and compared to the CAM RDMS (202), and then the Registered User's RDMS (203) is updated.

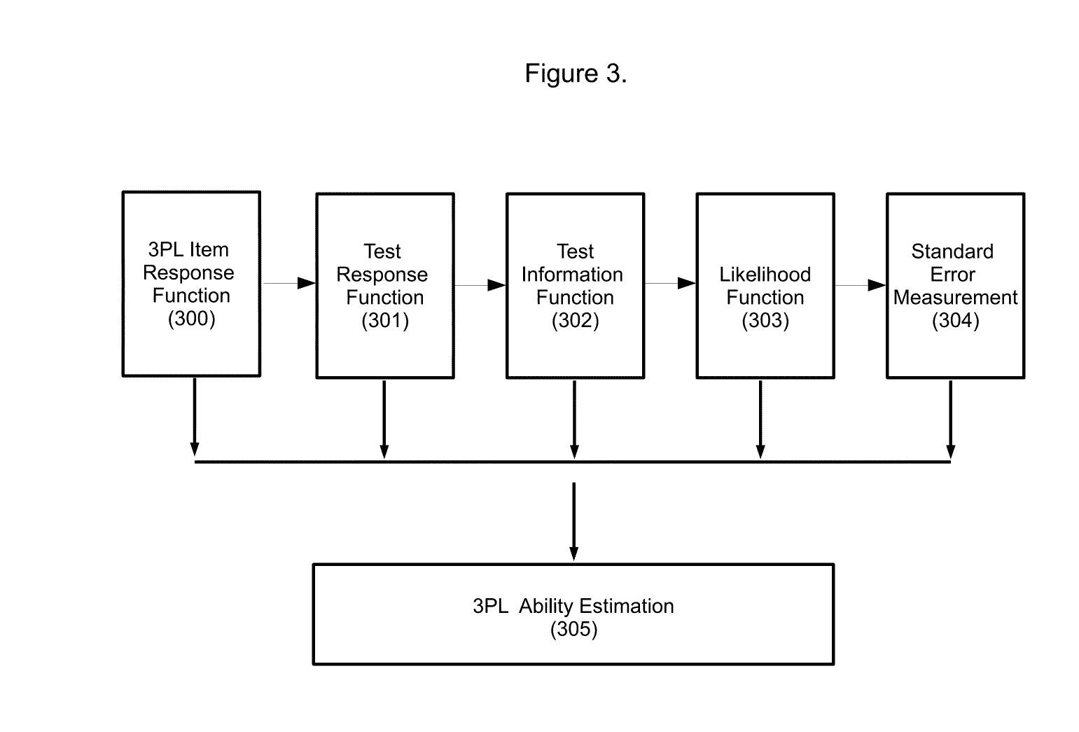

As shown in FIG. 3, during the course of normal operations and intended use, the User will be present with Dynamic Survey Questions presented in a poll format or questionnaire and answer format. Specifically the present invention uses, for example purposes, the 3PL Item Response Functions which means that each question or poll to user will have 3 possible answers. The PIRI INTELLGENT API (Item Response Function data processing Script)—will process the Item response using the appropriate algorithms for each equation. As applicable, the complete IRF data processing uses 3PL Item Response Functions (300), Test Response Functions (301), Test Information Function (302), Likelihood Function (303), and Standard Error Measurement (304), which, when combined, each function contributes to the method necessary to determine the user's ability or reasoning attributes based on 3PL Ability Estimations (305).

The following is a brief explanation of the equations for the Algorithms used to process the User's Item Response based on Psychometric Attributes and the User's Emotions.

The PIRI SUGGESTIVE API has an IRT (Item response Theory) Processing Script that processes and executes the following equations—IRT Models in order. The Test Response Function is the first equation.

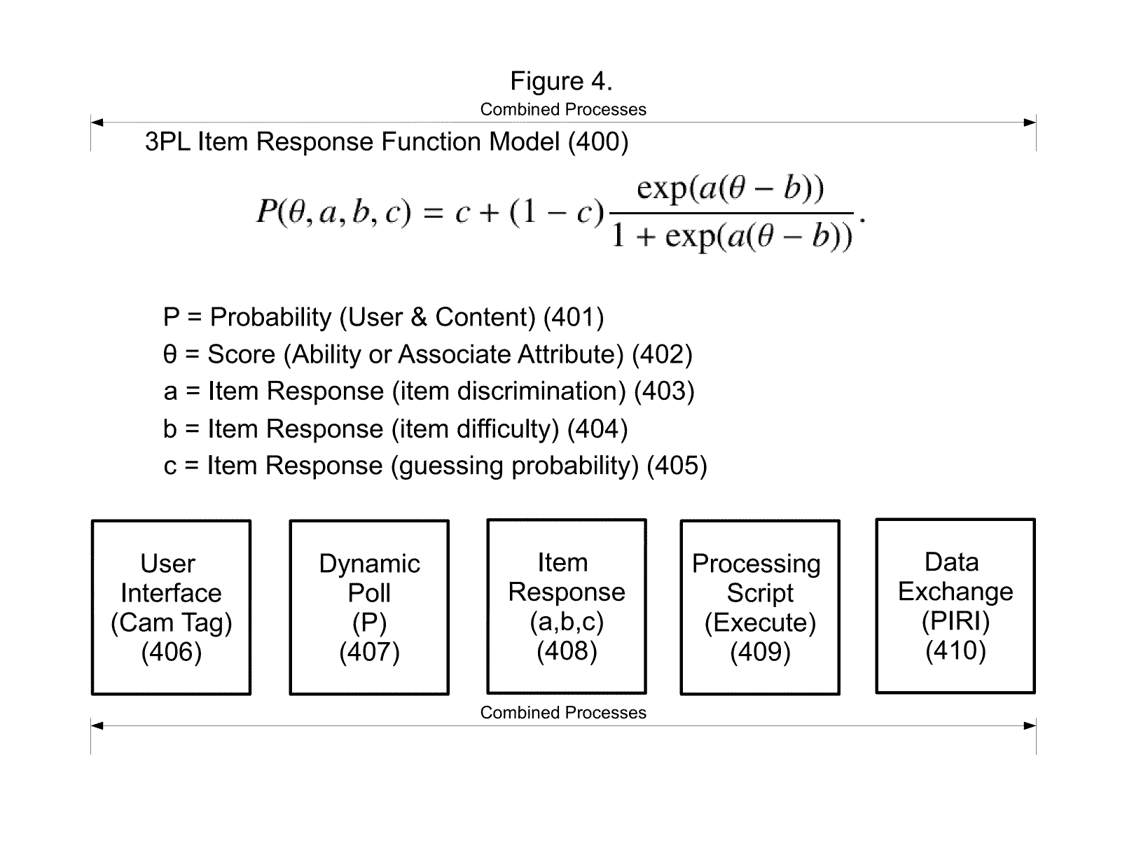

See FIG. 4—exemplary 3PL Item Response Function Model (400)

The Item Response Function Model (400) is used to process dynamic content distribution based on dynamic survey polls/questions that closely match the User's attributes and is dependent on the IRF Model and 3 parameter logistics (3PL) models. The Item Respond Function Model is used as a processing algorithm that the PIRI INTELLIGENT API uses to extract data from the various Relational Database Management Systems, and compares this information to the Registered User Interaction with the application using the IRF Model (400) and combined processes.

As shown in FIG. 4. the 3PL Item Response Function Model (400) is an equation based algorithm and function.

The following explains the function variables.

The variable P (401) (as in statistics) represent Probability—the probability that the Item Response Function will post when processed. This level of probable outcome data is used by the PIRI INTELLIGENT API to monitor, track, process, and suggest content to users as well as provide content suggestion regarding the specific nature of content that is targeted to users.

FIG. 4. features the equation and variables needed to process a combined process that inter-operates with the User Interface (406), Dynamic Survey (407), Item Responses (408), Processing Script (409) and Data Exchange using the PIRI INTELLIGENT API.

The Theta [θ} (402) is used to the score or process the user item response according to a given user attribute and item. Conventional variables (403) “a”, (404) “b”, and (405) “c” represent the item discrimination, the item difficulty and the item guessing probability.

Each item that is processed is used to post statistical data that triggers the PIRI SUGGESTION API library of processing scripts to respond according to data benchmarks and other statistics that is necessary to process the User Interface CAM Tag (406), the Dynamic Survey (407), the User Item Response (408) and exchange data with other database and statistical benchmarks and indications using Data Exchange (410) and executing IRF Processing Scripts (409) within the PIRI IN INTELLIGENT API.

The combined processes that FIG. 4 details are used in the following exemplary manner.

Item Response Function (IRF)—Exemplary Item Response Function (processing script)

$$P ( θ , a , b , c ) = c + ( 1 - c ) \frac{exp ( a ( θ - b ) )}{1 + exp ( a ( θ - b ) )} .$$

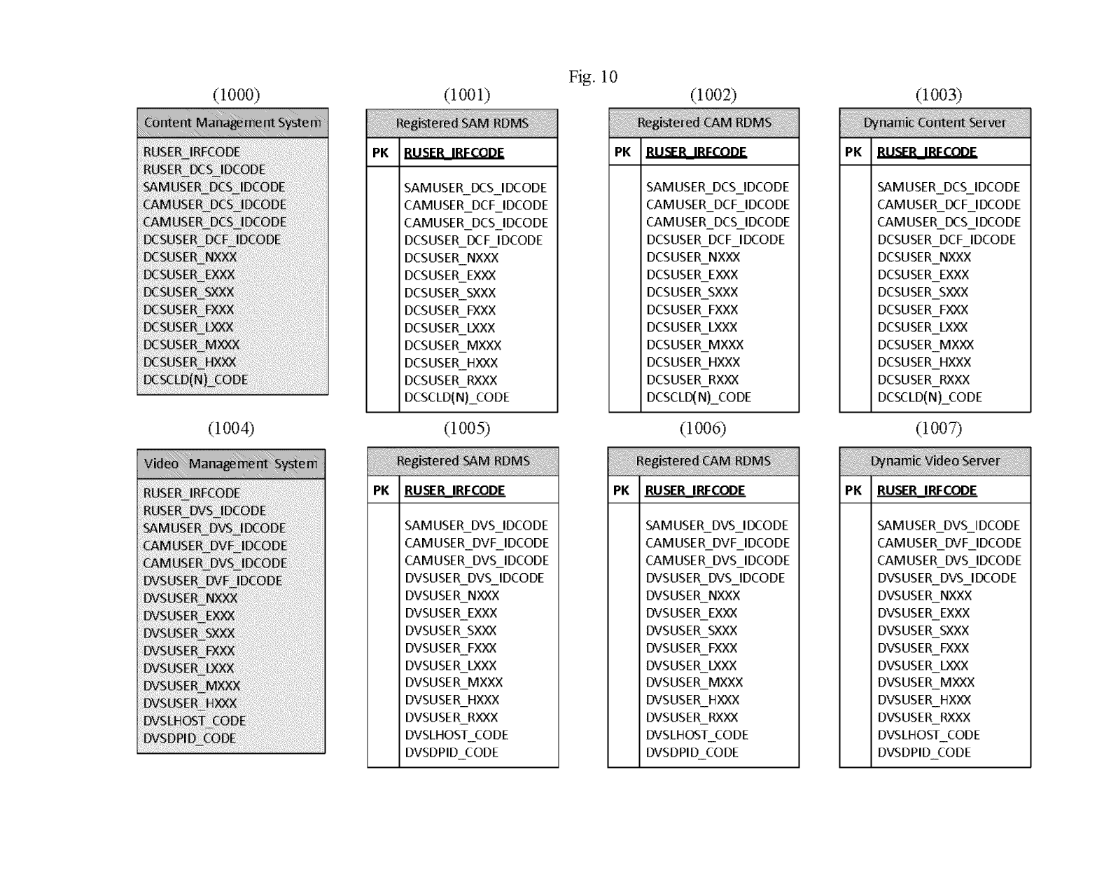

The Dynamic Content Distribution System uses the Item Response Function (IRF) equation as an algorithm to suggest digital content to end-users based on psychometric reasoning. The PIRI INTELLIGENT API uses the above Item Response Functions (IRF) equation as an algorithm to process the following entities featured in FIG. 10. These entities are (1000), (1001), (1002), (1003), (1004), (1004), (1005), (1006), and (1007).

The Tabular Data used in FIG. 10 UML Entity (1000) is encoded into the Content Management System and is used by the PIRI INTELLIGENT API to track, monitor and store how the user responds to content.

The Tabular Data used in FIG. 10 UML Entity (1001) is encoded into the Registered SAM RDMS and is used by the PIRI INTELLIGENT API to track, monitor and store how the user responds to content.

The Tabular Data used in FIG. 10 UML Entity (1002) is encoded into the Registered CAM RDMS and is used by the PIRI INTELLIGENT API to track, monitor and store how the user responds to content.

The Tabular Data used in FIG. 10 UML Entity (1003) is encoded into the Dynamic Content Server and is used by the PIRI INTELLIGENT API to track monitor and store how the user responds to content.

The Tabular Data used in FIG. 10 UML Entity (1004) is encoded into the Video Management System and is used by the PIRI INTELLIGENT API to track monitor and store how the user responds to video content.

The Tabular Data used in FIG. 10 UML Entity (1005) is encoded into the Registered SAM RDMS and is used by the PIRI INTELLIGENT API to track monitor and store how the user responds to video content.

The Tabular Data used in FIG. 10. UML Entity (1006) is encoded into the Registered CAM RDMS and is used by the PIRI INTELLIGENT API to track monitor and store how the user responds to video content.

The Tabular Data used in FIG. 10 UML Entity (1007) is encoded into the Dynamic Video Server and is used by the PIRI INTELLIGENT API to track monitor and store how users responds to video content.

All the UML Entities ranging from (1000) to (1007) sends data to the PIRI INTELLIGENT OPERATOR to determine how the Content is distributed to Register's Users.

In Table 1, Packages 1-8 contain Tabular Data that the PIRI Intelligent API uses in association with the relational database management system.

Package 1 is used to exchange data from the Registered User's RMDS.

Package 2 is used to exchange data that relates to the Registered User's extended demographics.

Package 3 is used to exchange data that relates to the Registered User's psychometric profile.

Package 4 is used to exchange data that relates to the Registered User's personality attributes.

Package 5 is used to exchange the dynamic content data with the relational databases contained in the Dynamic Content Distribution system.

Package 6 is used to exchange the dynamic video data with the relational databases contained in the Dynamic Content Distribution system.

Package 7 is used to exchange IRF data with relational databases contained in the Dynamic Content Distribution System.

Package 8 is used to exchange the Alphanumerical Identification Sequential Scores with each of the appropriate relational databases and servers.

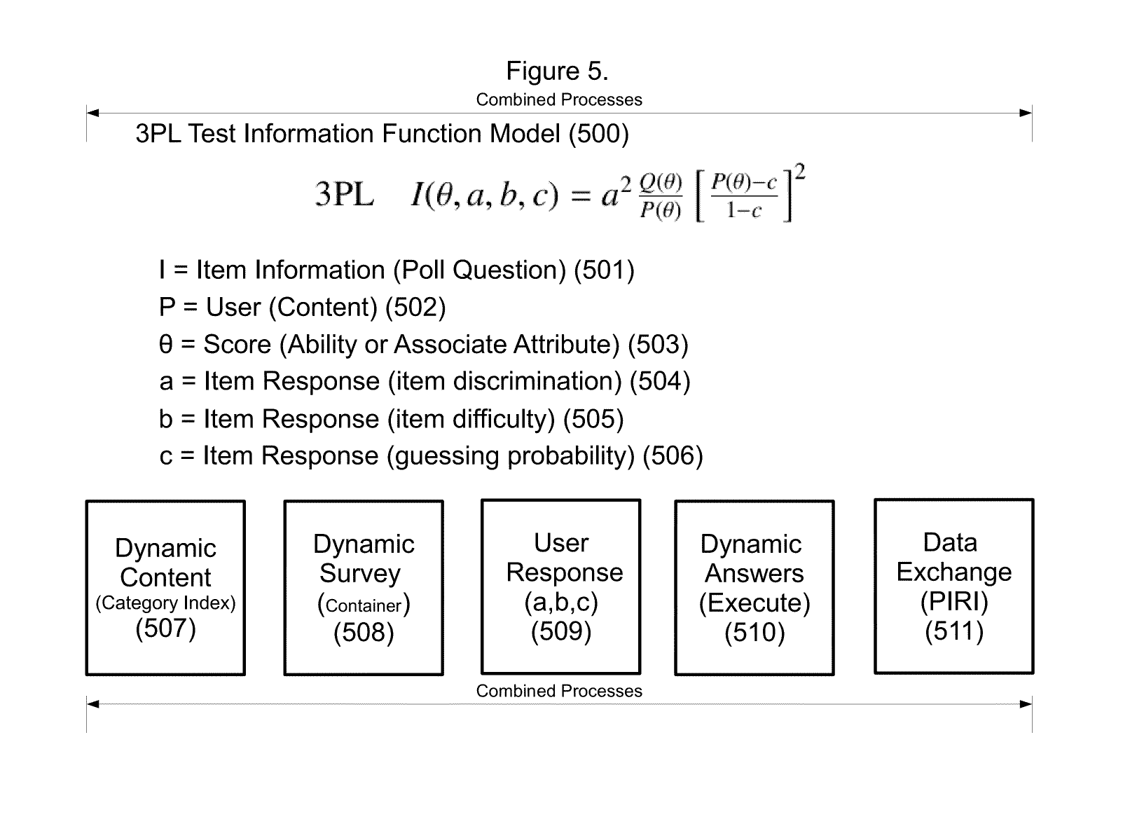

FIG. 5. 3PL Test Information Function Model (500)

The Test Information Function Model (500) is used to determine, track, store and estimate item information within the dynamic content distribution system and method based on Item Information (501), resulting probabilities, P (502), processing, track, store and estimate the User's score, as well the user's ability and associated attributes (503), The TIF Model is a 3 parameter logistics models that measures Items a, (504), b, (505), and c, (506). The Test Information Function Model is used as a processing algorithm that extracts data from the various Relational Database Management Systems, and compares this information to the Registered User Interaction with the application using the TIF Model (400) and combined processes.

As FIG. 5. features the 3PL Test Information Function Model (500) is an equation based algorithm based on the TIF Model Equation (500). This is important because the variables featured uses traditional and distinct processes as required by the Present Invention.

The following explains the variable functions

The variable I (501) represent the Item Information, that is featured by the Dynamic Survey Container (508) and the User Response (509) use variables, a (504), b (505), and c (506). This level of probable outcome data is used by the PIRI INTELLIGENT API to monitor, track, process, and suggest content to based on how the user respond to content.

FIG. 5. features the equation and variables need to Test Information Item Responses to influence content stored in the Dynamic Content Category Index (507), and Dynamic Survey Container (508), within the User Response (509) items “a”, “b”, and “c”. Dynamic Survey (508), User Responses (509), Dynamic Answers (510) and Data Exchange (511), and PIRI INTELLIGENT API.

Test Information Function (TIF)

Exemplary Test Information Function (Processing Script)

$${I}_{j} ( {θ}_{j} ) = {\sum }_{i} {I}_{ij} ( {θ}_{j} , {b}_{i} , {a}_{i} , {c}_{i} ) = {\sum }_{i} {a}^{2} {\frac{Q ( θ )}{P ( θ )} [ \frac{P ( θ ) - c}{1 - c} ]}^{2} .$$

The Dynamic Content Distribution System uses the Test Information Function (TIF) equation as an algorithm to compare Item Response statistical data and used the data to gather Test Information from end-users based on psychometric reasoning. The PIRI INTELLIGENT API uses the above Test Information Functions (TIF) equation as an algorithm to process the following entities featured in FIG. 10. These entities are (1000), (1001), (1002), (1003), (1004), (1004), (1005), (1006), and (1007).

The Tabular Data used in FIG. 10 UML Entity (1000) is encoded into the Content Management System and is used by the PIRI INTELLIGENT API to track, monitor and store the user test information.

The Tabular Data used in FIG. 10 UML Entity (1001) is encoded into the Registered SAM RDMS and is used by the PIRI INTELLIGENT API to track, monitor and store the user test information.

The Tabular Data used in FIG. 10 UML Entity (1002) is encoded into the Registered CAM RDMS and is used by the PIRI INTELLIGENT API to track, monitor and store the user test information.

The Tabular Data used in FIG. 10 UML Entity (1003) is encoded into the Dynamic Content Server and is used by the PIRI INTELLIGENT API to track monitor and store the user test information.

The Tabular Data used in FIG. 10 UML Entity (1004) is encoded into the Video Management System and is used by the PIRI INTELLIGENT API to track monitor and store the user test information.

The Tabular Data used in FIG. 10 UML Entity (1005) is encoded into the Registered SAM RDMS and is used by the PIRI INTELLIGENT API to track monitor and store the user test information.

The Tabular Data used in FIG. 10. UML Entity (1006) is encoded into the Registered CAM RDMS and is used by the PIRI INTELLIGENT API to track monitor and store the user test information.

The Tabular Data used in FIG. 10 UML Entity (1007) is encoded into the Dynamic Video Server and is used by the PIRI INTELLIGENT API to track monitor and store the user test information.

All the UML Entities ranging from (1000) to (1007) sends data to the PIRI INTELLIGENT OPERATOR to determine how the Register's Users test information is distributed.

In Table 1, Packages 1-8 contain Tabular Data that the PIRI Intelligent API uses in association with the relational database management system.

Package 1 is used to exchange data from the Registered User's RMDS.

Package 2 is used to exchange data that relates to the Registered User's extended demographics.

Package 3 is used to exchange data that relates to the Registered User's psychometric profile.

Package 4 is used to exchange data that relates to the Registered User's personality attributes.

Package 5 is used to exchange the dynamic content data with the relational databases contained in the Dynamic Content Distribution system.

Package 6 is used to exchange the dynamic video data with the relational databases contained in the Dynamic Content Distribution system.

Package 7 is used to exchange IRF data with relational databases contained in the Dynamic Content Distribution System.

Package 8 is used to exchange the Alphanumerical Identification Sequential Scores with each of the appropriate relational databases and servers.

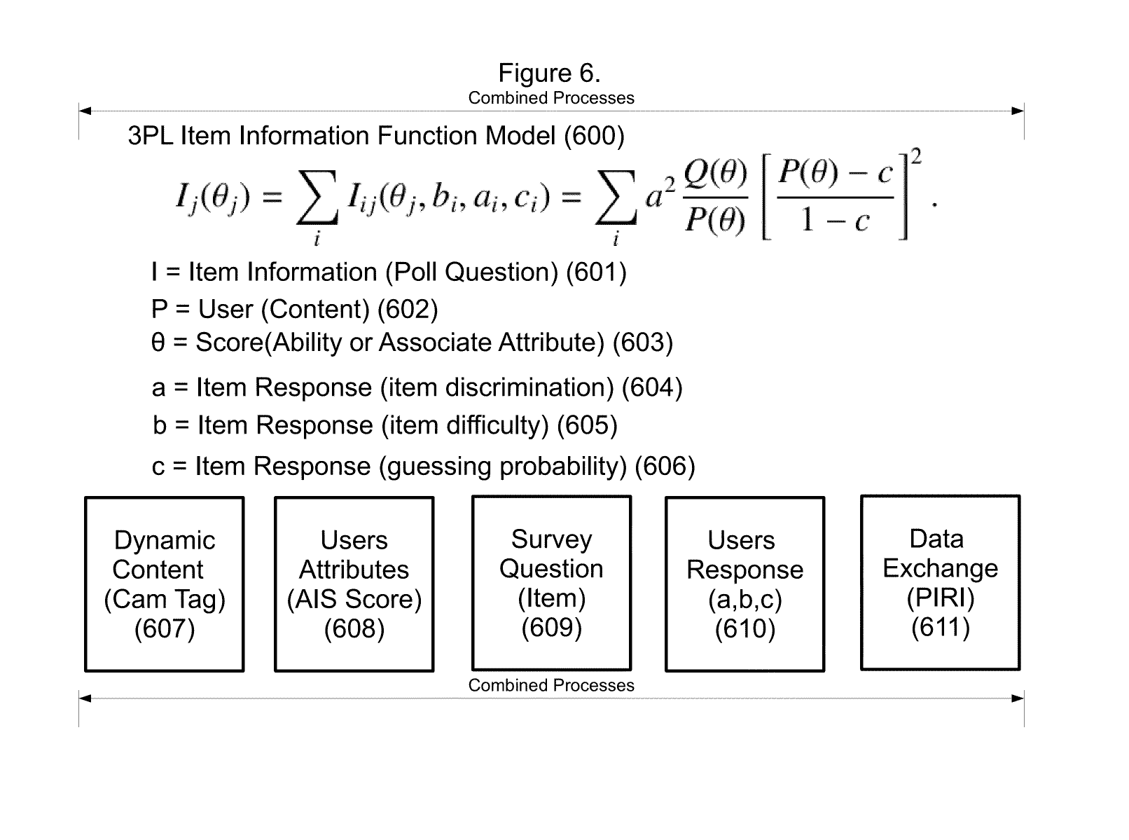

FIG. 6. 3PL Item Information Function Model (600)

The Item Information Function Model (600) is used to determine, track, store and estimate item information such as user responses based on Item Information processing within the dynamic content distribution system and method based on following variables; Item Information (601), resulting probabilities, P (602), processing, track, store and the user's dynamic and history Item Responses, as well the user's ability and associated attributes (603), The IIF Model is a 3 parameter logistics models that measures Item Information pertaining to survey questions and variables a, (604), b, (605), and c, (606). The Item Information Function Model is used as a processing algorithm that extracts data from the various Relational Database Management Systems, and compares this information to the Registered User Interaction with the application using the IIF Model (600) and combined processes.

As FIG. 6. features the 3PL Item Information Function Model (600) is an equation based algorithm based on the TIF Model Equation (600) that program to functions several distinct and altered ways. This is important because the variables featured uses traditional and distinct processes as required by the Present Invention.

The following explains the variable functions

The variable I (601) represent the Item Information, that is feature in or as a response to Dynamic Content (607) and the Survey Question Items (608) present the user with 3 variables, processed by Items, a (604), b (605), and c (606). This level of probable outcome data is used by the PIRI INTELLIGENT API to monitor, track, process, and suggest content to based on how the user respond to content.

FIG. 6. features the equation and variables need to present Item Information and track Item Responses that ultimately influence content stored in the Dynamic Content Server (607), targeted toward the User Attributes (608), when the user indicate a response,—User's Response—(510) “a”, “b”, and “c”. Dynamic Survey (508), User Responses (509), Dynamic Answers (510) and Data Exchange (511), and PIRI INTELLIGENT API.

Item Information Function (IIF)

Exemplary Item Inform Function (Processing Script)

$$I ( θ , a , b , c ) = {a}^{2} {\frac{Q ( θ )}{P ( θ )} [ \frac{P ( θ ) - c}{1 - c} ]}^{2} \qquad 3 PL$$

The Dynamic Content Distribution System uses the Item Information Function (IIF) equation as an algorithm to track item information based on psychometric reasoning. The PIRI INTELLIGENT API uses the above Item Information Functions (IIF) equation as an algorithm to process the following entities featured in FIG. 10. These entities are (1000), (1001), (1002), (1003), (1004), (1004), (1005), (1006), and (1007).

The Tabular Data used in FIG. 10 UML Entity (1000) is encoded into the Content Management System and is used by the PIRI INTELLIGENT API to track, monitor, store and post item information.

The Tabular Data used in FIG. 10 UML Entity (1001) is encoded into the Registered SAM RDMS and is used by the PIRI INTELLIGENT API to track, monitor, store and post item information.

The Tabular Data used in FIG. 10 UML Entity (1002) is encoded into the Registered CAM RDMS and is used by the PIRI INTELLIGENT API to track, monitor, store and post item information.

The Tabular Data used in FIG. 10 UML Entity (1003) is encoded into the Dynamic Content Server and is used by the PIRI INTELLIGENT API to track, monitor, store and post item information.

The Tabular Data used in FIG. 10 UML Entity (1004) is encoded into the Video Management System and is used by the PIRI INTELLIGENT API to track monitor, store and post item information.

The Tabular Data used in FIG. 10 UML Entity (1005) is encoded into the Registered SAM RDMS and is used by the PIRI INTELLIGENT API to track monitor, store and post item information.

The Tabular Data used in FIG. 10. UML Entity (1006) is encoded into the Registered CAM RDMS and is used by the PIRI INTELLIGENT API to track monitor, store and post item information for video content.

The Tabular Data used in FIG. 10 UML Entity (1007) is encoded into the Dynamic Video Server and is used by the PIRI INTELLIGENT API to track monitor, store and post item information.

All the UML Entities ranging from (1000) to (1007) sends data to the PIRI INTELLIGENT OPERATOR to determine how the Item Information is retrieved from Register's Users.

In Table 1, Packages 1-8 contain Tabular Data that the PIRI Intelligent API uses in association with the relational database management system.

Package 1 is used to exchange data from the Registered User's RMDS.

Package 2 is used to exchange data that relates to the Registered User's extended demographics.

Package 3 is used to exchange data that relates to the Registered User's psychometric profile.

Package 4 is used to exchange data that relates to the Registered User's personality attributes.

Package 5 is used to exchange the dynamic content data with the relational databases contained in the Dynamic Content Distribution system.

Package 6 is used to exchange the dynamic video data with the relational databases contained in the Dynamic Content Distribution system.

Package 7 is used to exchange IRF data with relational databases contained in the Dynamic Content Distribution System.

Package 8 is used to exchange the Alphanumerical Identification Sequential Scores with each of the appropriate relational databases and servers.

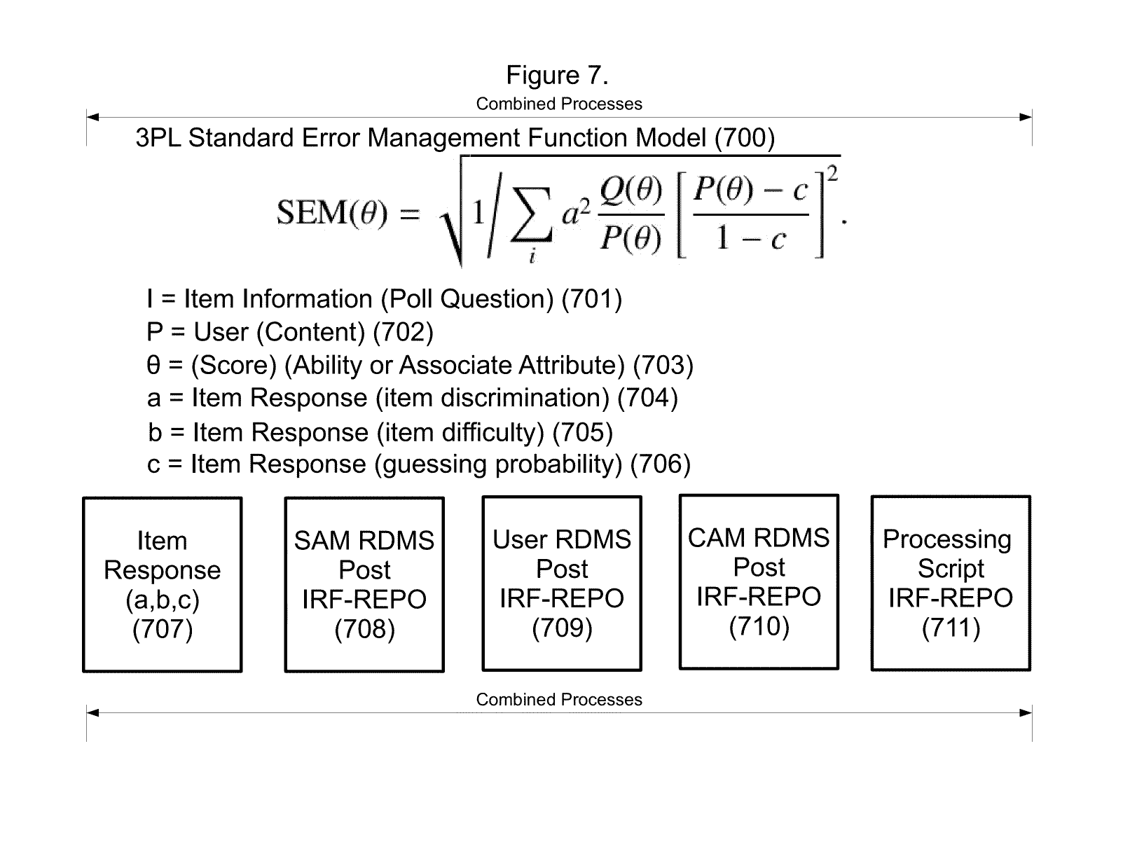

FIG. 7. 3PL Standard Error Management Function Model (700)

The Standard Error Management Function Model (700) is used to determine, track, store and estimate SEM during the following process, the Item Response (707) Process for SEM, SAM RDMS Post to IRF Repository (708), the Registered User RDMS Post to IRF Repository (709), and the CAM RDMS IRF Repository using the Processing Script (710) to exchange data across IRF Repository Table.

Standard Error Management Function Model (SEM)

Exemplary Standard Error Management (Processing Script)

$$SEM ( θ ) = \sqrt{1 / {\sum }_{i} {a}^{2} {\frac{Q ( θ )}{P ( θ )} [ \frac{P ( θ ) - c}{1 - c} ]}^{2}} .$$

The Dynamic Content Distribution System uses the Standard Error Management Function Model (SEM) equation as an algorithm to suggest digital content to end-users based on psychometric reasoning. The PIRI INTELLIGENT API uses the above Standard Error Management Function Model (SEM) equation as an algorithm to process the following entities featured in FIG. 10. These entities are (1000), (1001), (1002), (1003), (1004), (1004), (1005), (1006), and (1007).

The Tabular Data used in FIG. 10 UML Entity (1000) is encoded into the Content Management System and is used by the PIRI INTELLIGENT API to track, monitor, store and post Standard Error Management data.

The Tabular Data used in FIG. 10 UML Entity (1001) is encoded into the Registered SAM RDMS and is used by the PIRI INTELLIGENT API to track, monitor, store and post Standard Error Management data.

The Tabular Data used in FIG. 10 UML Entity (1002) is encoded into the Registered CAM RDMS and is used by the PIRI INTELLIGENT API to track, monitor, store and post Standard Error Management data.

The Tabular Data used in FIG. 10 UML Entity (1003) is encoded into the Dynamic Content Server and is used by the PIRI INTELLIGENT API to track, monitor, store and post Standard Error Management data.

The Tabular Data used in FIG. 10 UML Entity (1004) is encoded into the Video Management System and is used by the PIRI INTELLIGENT API to track, monitor, store and post Standard Error Management data.

The Tabular Data used in FIG. 10 UML Entity (1005) is encoded into the Registered SAM RDMS and is used by the PIRI INTELLIGENT API to track, monitor, store and post Standard Error Management data.

The Tabular Data used in FIG. 10. UML Entity (1006) is encoded into the Registered CAM RDMS and is used by the PIRI INTELLIGENT API to track, monitor, store and post Standard Error Management data.

The Tabular Data used in FIG. 10 UML Entity (1007) is encoded into the Dynamic Video Server and is used by the PIRI INTELLIGENT API to track, monitor, store and post Standard Error Management data.

All the UML Entities ranging from (1000) to (1007) sends data to the PIRI INTELLIGENT OPERATOR to track the Register's Users Standard Error Management data.

In Table 1, Packages 1-8 contain Tabular Data that the PIRI Intelligent API uses in association with the relational database management system.

Package 1 is used to exchange data from the Registered User's RMDS.

Package 2 is used to exchange data that relates to the Registered User's extended demographics.

Package 3 is used to exchange data that relates to the Registered User's psychometric profile.

Package 4 is used to exchange data that relates to the Registered User's personality attributes.

Package 5 is used to exchange the dynamic content data with the relational databases contained in the Dynamic Content Distribution system.

Package 6 is used to exchange the dynamic video data with the relational databases contained in the Dynamic Content Distribution system.

Package 7 is used to exchange IRF data with relational databases contained in the Dynamic Content Distribution System.

Package 8 is used to exchange the Alphanumerical Identification Sequential Scores with each of the appropriate relational databases and servers.

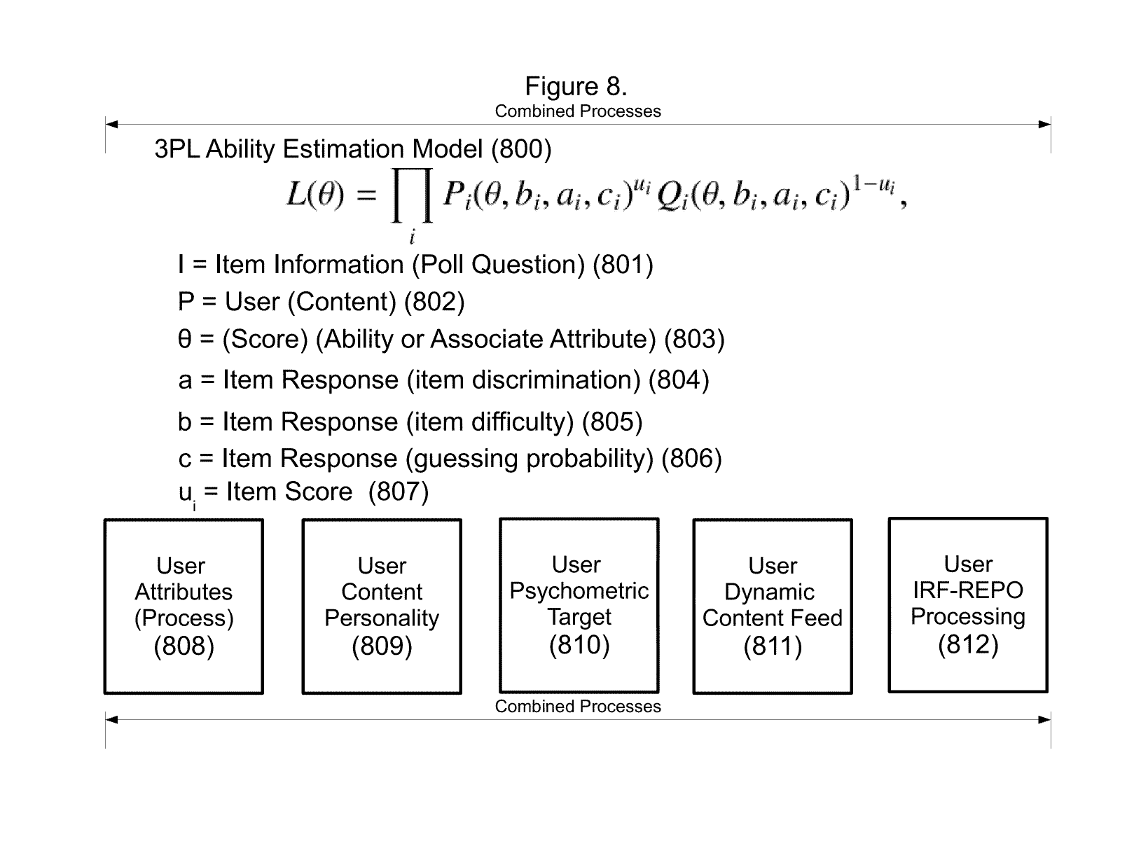

FIG. 8. 3PL Ability Estimation Model (800)

The Ability Estimation Model is used by the AEM Algorithm to determine, track, and store abilities by using the Ability Estimate Model (800) by extracting relevant data from the User Attributes Process (808), the User Content Personality (809), the User psychometric Target (810), the User Dynamic Content Feed (811) and the IRF-REPO Processing (812).

Ability Estimation Model (AEM)

Ability Estimation Model (Processing Script)

$$L ( θ ) = {\prod }_{i} {{P}_{i} ( θ , {b}_{i} , {a}_{i} , {c}_{i} )}^{{u}_{i}} {{Q}_{i} ( θ , {b}_{i} , {a}_{i} , {c}_{i} )}^{1 - {u}_{i}} ,$$

The Dynamic Content Distribution System uses the Ability Estimation Model (AEM) equation as an algorithm to suggest digital content to end-users based on psychometric comparable and historical ability estimation. The PIRI INTELLIGENT API uses the above Ability Estimation Model (AEM) equation as an algorithm to process the following entities featured in FIG. 10. These entities are (1000), (1001), (1002), (1003), (1004), (1004), (1005), (1006), and (1007).

The Tabular Data used in FIG. 10 UML Entity (1000) is encoded into the Content Management System and is used by the PIRI INTELLIGENT API to track, monitor and store how the user responds to content to measure and forecast the User's psychometric abilities.

The Tabular Data used in FIG. 10 UML Entity (1001) is encoded into the Registered SAM RDMS and is used by the PIRI INTELLIGENT API to track, monitor and store how the user responds to content to measure and forecast the User's psychometric abilities.

The Tabular Data used in FIG. 10 UML Entity (1002) is encoded into the Registered CAM RDMS and is used by the PIRI INTELLIGENT API to track, monitor and store how the user responds to content to measure and forecast the User's psychometric abilities.

The Tabular Data used in FIG. 10 UML Entity (1003) is encoded into the Dynamic Content Server and is used by the PIRI INTELLIGENT API to track monitor and store how the user responds to content to measure and forecast the User's psychometric abilities.

The Tabular Data used in FIG. 10 UML Entity (1004) is encoded into the Video Management System and is used by the PIRI INTELLIGENT API to track monitor and store how the user responds to video content to measure and forecast the User's psychometric abilities.

The Tabular Data used in FIG. 10 UML Entity (1005) is encoded into the Registered SAM RDMS and is used by the PIRI INTELLIGENT API to track monitor and store how the user responds to video content to measure and forecast the User's psychometric abilities.

The Tabular Data used in FIG. 10. UML Entity (1006) is encoded into the Registered CAM RDMS and is used by the PIRI INTELLIGENT API to track monitor and store how the user responds to video content to measure and forecast the User's psychometric abilities.

The Tabular Data used in FIG. 10 UML Entity (1007) is encoded into the Dynamic Video Server and is used by the PIRI INTELLIGENT API to track monitor and store how users responds to video content to measure and forecast the User's psychometric abilities.

All the UML Entities ranging from (1000) to (1007) sends data to the PIRI INTELLIGENT OPERATOR to determine how the Content is distributed to Register's Users.

In Table 1, Packages 1-8 contain Tabular Data that the PIRI Intelligent API uses in association with the relational database management system.

Package 1 is used to exchange data from the Registered User's RMDS.

Package 2 is used to exchange data that relates to the Registered User's extended demographics.

Package 3 is used to exchange data that relates to the Registered User's psychometric profile.

Package 4 is used to exchange data that relates to the Registered User's personality attributes.

Package 5 is used to exchange the dynamic content data with the relational databases contained in the Dynamic Content Distribution system.

Package 6 is used to exchange the dynamic video data with the relational databases contained in the Dynamic Content Distribution system.

Package 7 is used to exchange IRF data with relational databases contained in the Dynamic Content Distribution System.

Package 8 is used to exchange the Alphanumerical Identification Sequential Scores with each of the appropriate relational databases and servers.

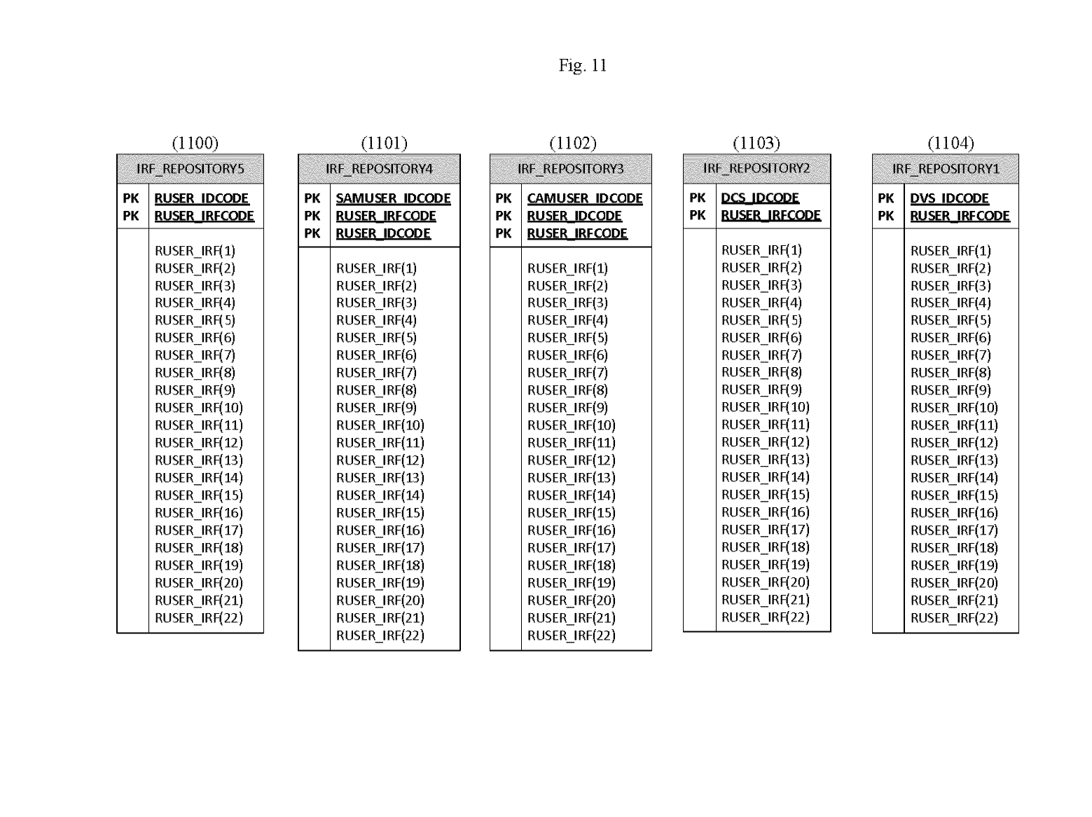

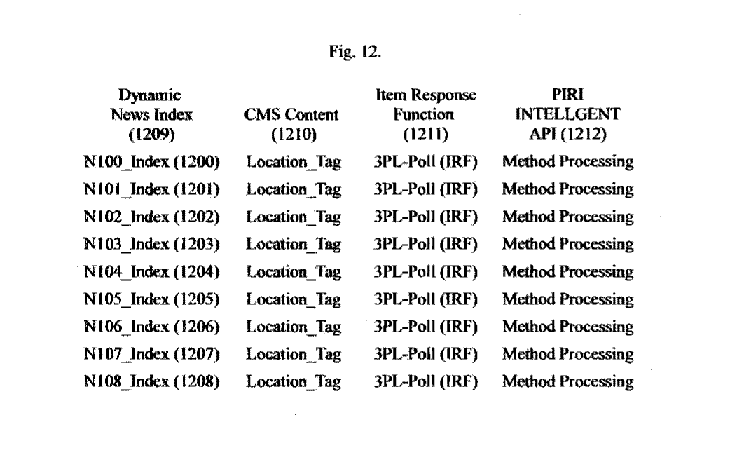

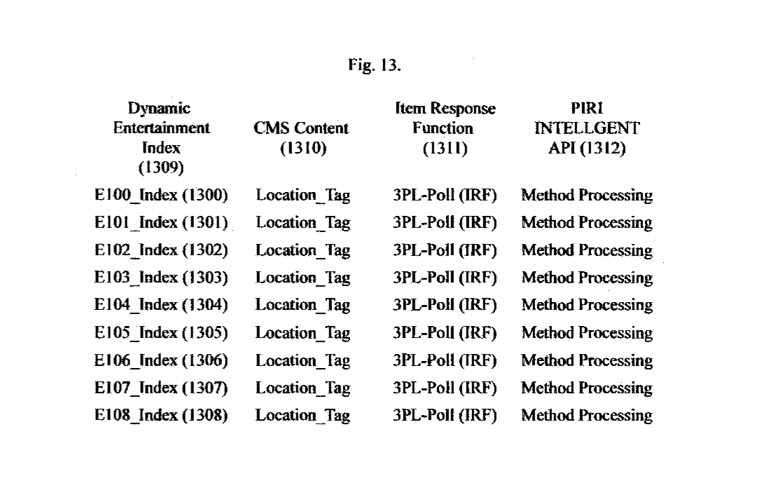

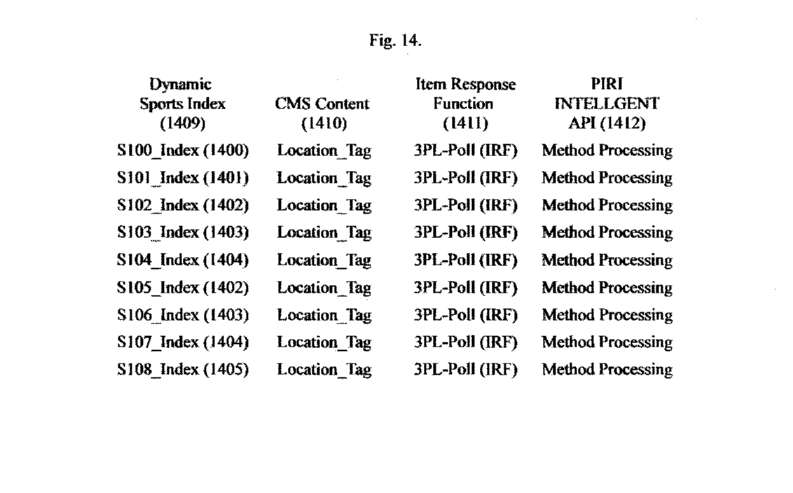

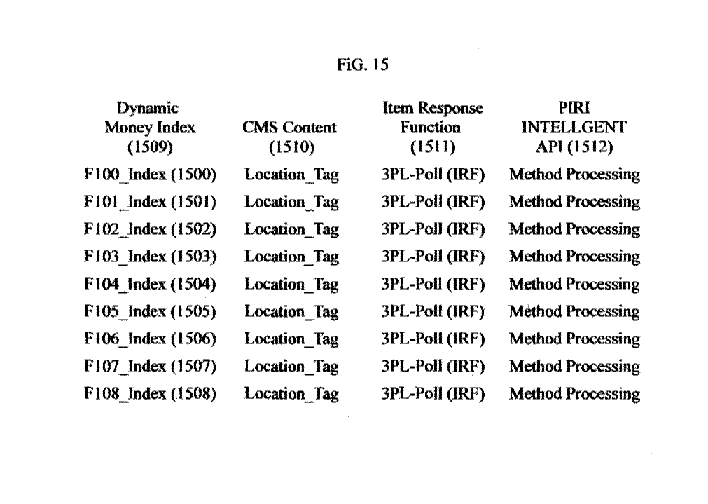

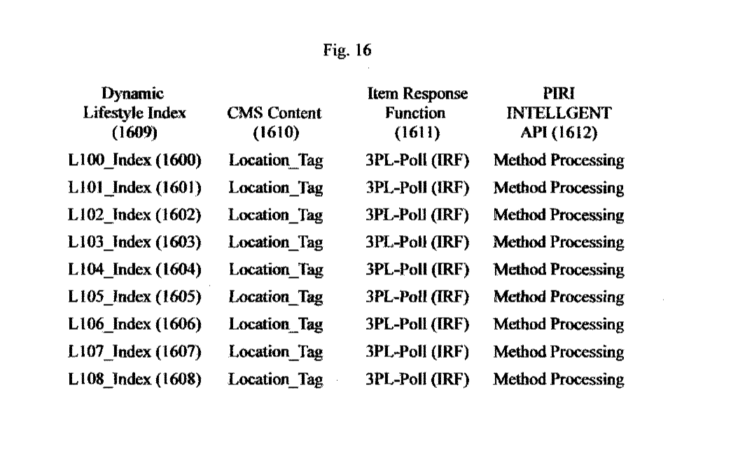

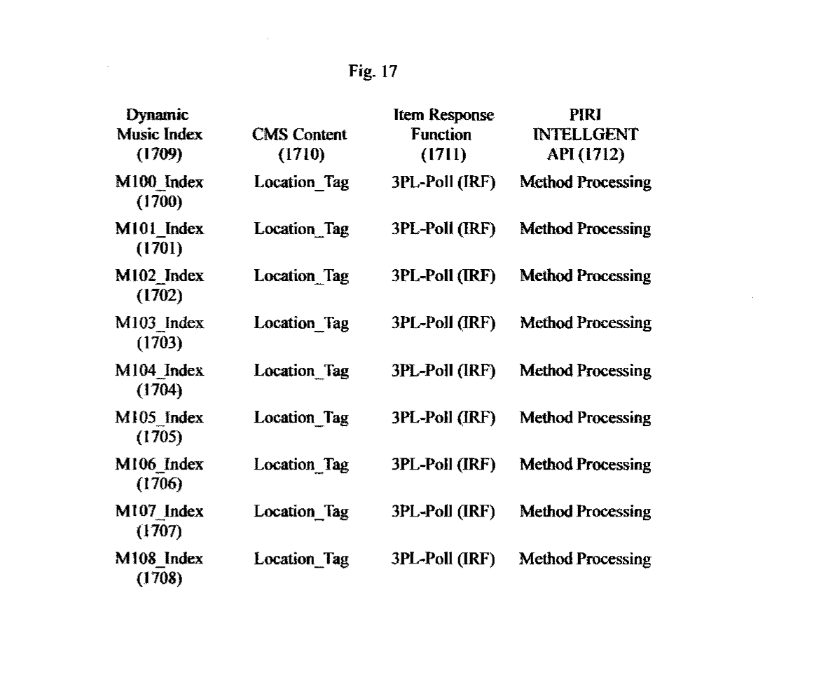

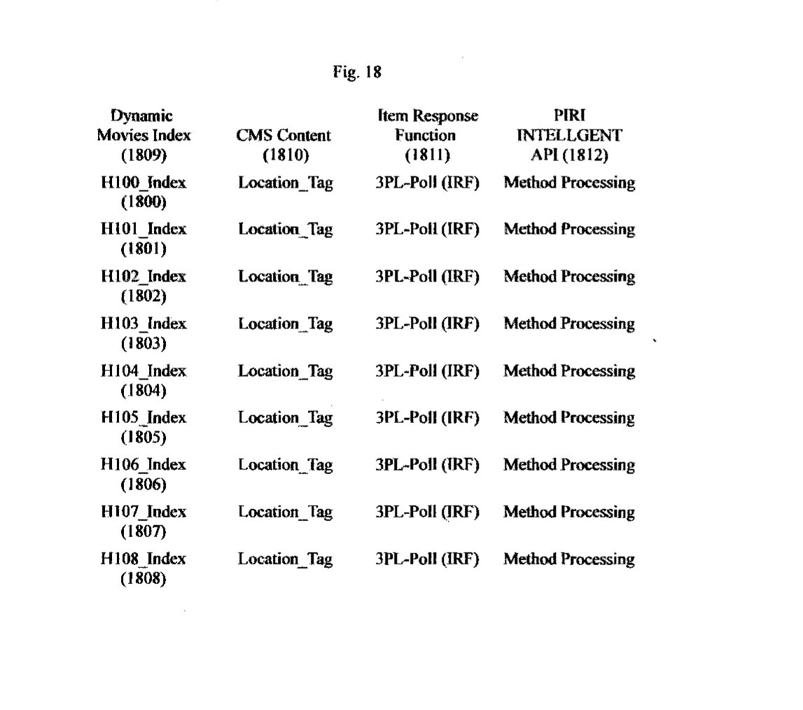

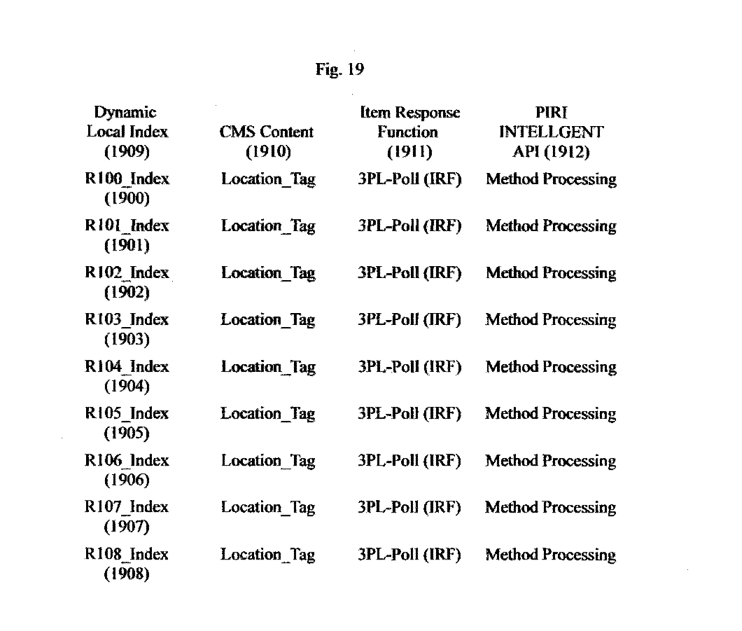

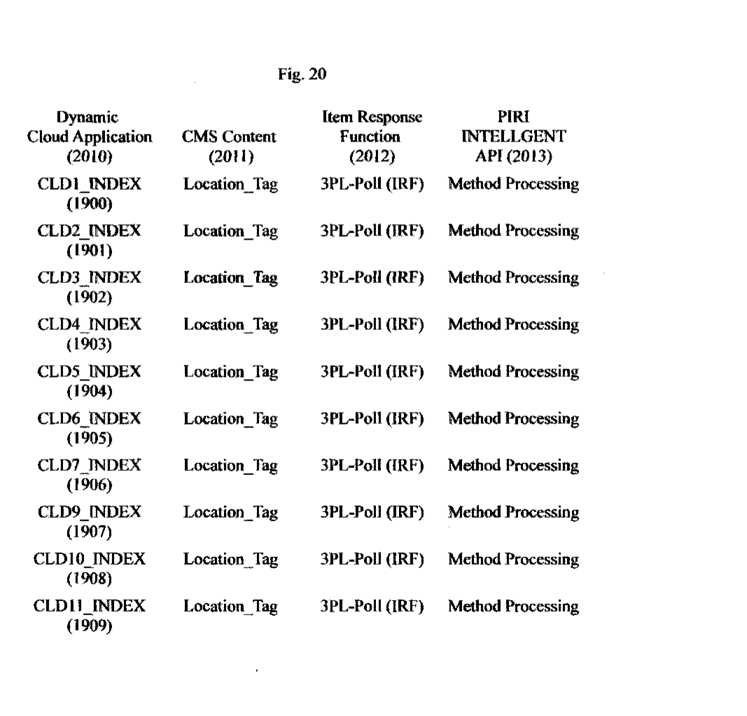

FIG. 11. IRF RESPOSITORY DATA

Item Response Functions are used to exchange data to and from and with the (1100) Registered User IRF Repository

Item Response Functions are used to exchange data to and from and with the (1101) SAM User IRF Repository

Item Response Functions are used to exchange data to and from and with the (1102) CAM User IRF Repository

Item Response Functions are used to exchange data to and from and with the (1103) Dynamic Content Distribution IRF Repository

Item Response Functions are used to exchange data to and from and with the (1104) Dynamic Video Content Distribution IRF Repository

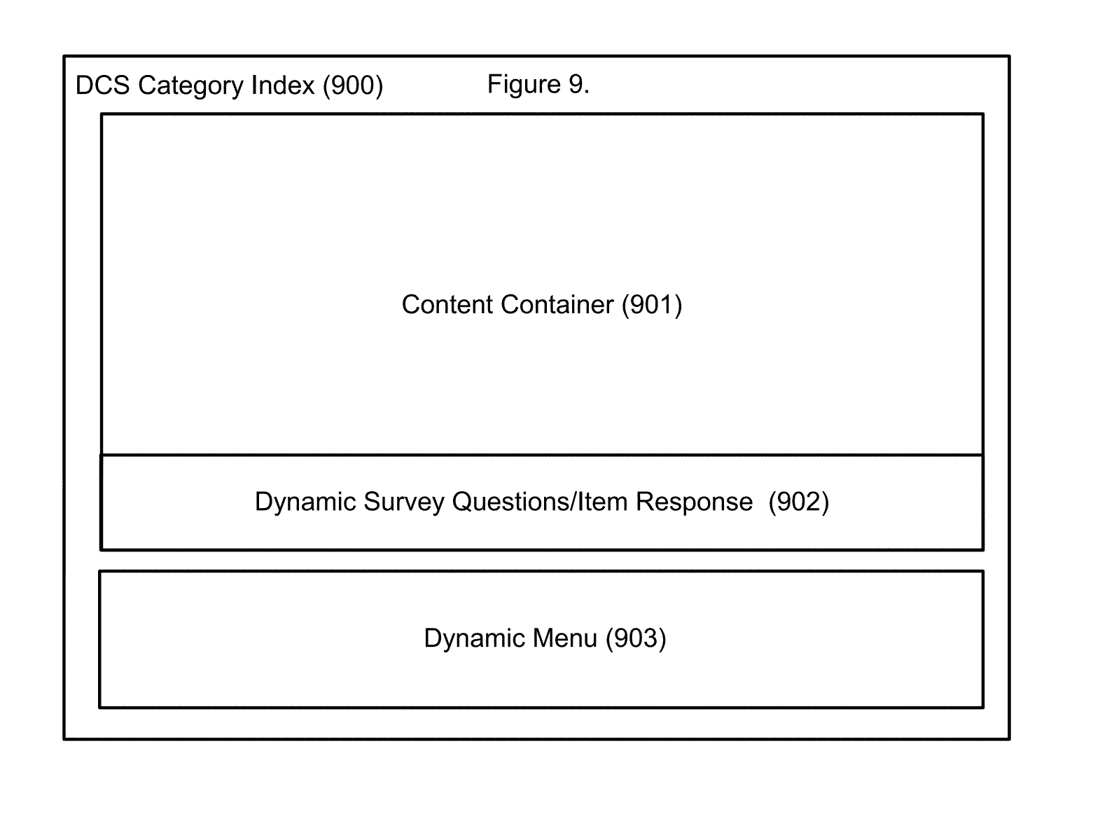

FIG. 9. Dynamic Content Distribution (User Interface)

In order for the Dynamic Content Distribution System stores and distribute dynamic content in the following manager. The User Dynamic Content Server stores the necessary locating and statistical data for content in the following manner; the Category Index (900) store the location of the category. The User Interface is populated when a specific category index is chosen from the Dynamic Menu (903). The Category Index Content Page (900) contains the Content Container (901). The digital content that is presented inside the content container is presented to user based on the User's Psychometric, Socio-demographic, and Emotional bases, as well how the user responds to intermittent dynamic survey questions (902).

The Dynamic New Index (1209) is a category within the Dynamic Content Distribution System that is used to distribute dynamic news content based on the user psychometric and socio-demographic attributes to the user's via a Content Management System—CMS—(1210). When the User clicks—select—content the interaction is tracked using Item Response Functions (1211) that are processed by the PIRI INTELLIGENT API (1212).

The sub News Index, N100_Index(1200) is identified and located using a Location_Tag and each location tag is encoded with 3PL Item Response Functions and PIRI INTELLIGENT API (1212) processes the Item Response Method chosen.

The sub News Index, N101_Index(1201) is identified and located using a Location_Tag and each location tag is encoded with 3PL Item Response Functions and PIRI INTELLIGENT API (1212) processes the Item Response Method chosen.

The sub News Index, N102_Index(1202) is identified and located using a Location_Tag and each location tag is encoded with 3PL Item Response Functions and PIRI INTELLIGENT API (1212) processes the Item Response Method chosen.

The sub News Index, N103_Index(1203) is identified and located using a Location_Tag and each location tag is encoded with 3PL Item Response Functions and PIRI INTELLIGENT API (1212) processes the Item Response Method chosen.

The sub News Index, N104_Index(1204) is identified and located using a Location_Tag and each location tag is encoded with 3PL Item Response Functions and PIRI INTELLIGENT API (1212) processes the Item Response Method chosen.

The sub News Index, N105_Index(1205) is identified and located using a Location_Tag and each location tag is encoded with 3PL Item Response Functions and PIRI INTELLIGENT API (1212) processes the Item Response Method chosen.

The sub News Index, N106_Index(1206) is identified and located using a Location_Tag and each location tag is encoded with 3PL Item Response Functions and PIRI INTELLIGENT API (1212) processes the Item Response Method chosen.

The sub News Index, N107_Index(1207) is identified and located using a Location_Tag and each location tag is encoded with 3PL Item Response Functions and PIRI INTELLIGENT API (1212) processes the Item Response Method chosen.

The sub News Index, N108_Index(1208) is identified and located using a Location_Tag and each location tag is encoded with 3PL Item Response Functions and PIRI INTELLIGENT API (1212) processes the Item Response Method chosen.

The Dynamic Entertainment Index (1309) is a category within the Dynamic Content Distribution System that is used to distribute dynamic entertainment content based on the user psychometric and socio-demographic attributes to the user's via a Content Management System—CMS—(1310). When the User clicks—select—content the interaction is tracked using Item Response Functions (1311) that are processed by the PIRI INTELLIGENT API (1312).

The sub Entertainment Index, E100_Index(1300) is identified and located using a Location_Tag and each location tag is encoded with 3PL Item Response Functions and PIRI INTELLIGENT API (1312) processes the Item Response Method chosen.

The sub News Index, E101_Index(1301) is identified and located using a Location_Tag and each location tag is encoded with 3PL Item Response Functions and PIRI INTELLIGENT API (1312) processes the Item Response Method chosen.

The sub News Index, E102_Index(1302) is identified and located using a Location_Tag and each location tag is encoded with 3PL Item Response Functions and PIRI INTELLIGENT API (1312) processes the Item Response Method chosen.

The sub Entertainment Index, E103_Index(1303) is identified and located using a Location_Tag and each location tag is encoded with 3PL Item Response Functions and PIRI INTELLIGENT API (1312) processes the Item Response Method chosen.

The sub Entertainment Index, E104_Index(1304) is identified and located using a Location_Tag and each location tag is encoded with 3PL Item Response Functions and PIRI INTELLIGENT API (1312) processes the Item Response Method chosen.

The sub Entertainment Index, E105_Index(1305) is identified and located using a Location_Tag and each location tag is encoded with 3PL Item Response Functions and PIRI INTELLIGENT API (1312) processes the Item Response Method chosen.

The sub Entertainment Index, E106_Index(1306) is identified and located using a Location_Tag and each location tag is encoded with 3PL Item Response Functions and PIRI INTELLIGENT API (1312) processes the Item Response Method chosen.

The sub Entertainment Index, E107_Index(1307) is identified and located using a Location_Tag and each location tag is encoded with 3PL Item Response Functions and PIRI INTELLIGENT API (1312) processes the Item Response Method chosen.

The sub Entertainment Index, E108_Index(1308) is identified and located using a Location_Tag and each location tag is encoded with 3PL Item Response Functions and PIRI INTELLIGENT API (1312) processes the Item Response Method chosen.

The Dynamic Sports Index (1409) is a category within the Dynamic Content Distribution System that is used to distribute dynamic Sports content based on the user psychometric and socio-demographic attributes to the user's via a Content Management System—CMS—(1410). When the User clicks—select—content the interaction is tracked using Item Response Functions (1411) that are processed by the PIRI INTELLIGENT API (1412).

The sub Sports Index, S100_Index(1400) is identified and located using a Location_Tag and each location tag is encoded with 3PL Item Response Functions and PIRI INTELLIGENT API (1412) processes the Item Response Method chosen.

The sub Sports Index, S101_Index(1401) is identified and located using a Location_Tag and each location tag is encoded with 3PL Item Response Functions and PIRI INTELLIGENT API (1412) processes the Item Response Method chosen.

The sub Sports Index, S102_Index(1402) is identified and located using a Location_Tag and each location tag is encoded with 3PL Item Response Functions and PIRI INTELLIGENT API (1412) processes the Item Response Method chosen.

The sub Sports Index, S103_Index(1403) is identified and located using a Location_Tag and each location tag is encoded with 3PL Item Response Functions and PIRI INTELLIGENT API (1412) processes the Item Response Method chosen.

The sub Sports Index, S104_Index(1404) is identified and located using a Location_Tag and each location tag is encoded with 3PL Item Response Functions and PIRI INTELLIGENT API (1412) processes the Item Response Method chosen.

The sub Sports Index, S105_Index(1405) is identified and located using a Location_Tag and each location tag is encoded with 3PL Item Response Functions and PIRI INTELLIGENT API (1412) processes the Item Response Method chosen.

The sub Sports Index, S106_Index(1406) is identified and located using a Location_Tag and each location tag is encoded with 3PL Item Response Functions and PIRI INTELLIGENT API (1412) processes the Item Response Method chosen.

The sub Sports Index, S107_Index(1407) is identified and located using a Location_Tag and each location tag is encoded with 3PL Item Response Functions and PIRI INTELLIGENT API (1412) processes the Item Response Method chosen.

The sub Sports Index, S108_Index(1408) is identified and located using a Location_Tag and each location tag is encoded with 3PL Item Response Functions and PIRI INTELLIGENT API (1412) processes the Item Response Method chosen.

The Dynamic Money Index (1509) is a category within the Dynamic Content Distribution System that is used to distribute dynamic Money content based on the user psychometric and socio-demographic attributes to the user's via a Content Management System—CMS—(1510). When the User clicks—select—content the interaction is tracked using Item Response Functions (1511) that are processed by the PIRI INTELLIGENT API (1512).

The sub Money Index, F100_Index(1500) is identified and located using a Location_Tag and each location tag is encoded with 3PL Item Response Functions and PIRI INTELLIGENT API (1512) processes the Item Response Method chosen.

The sub Money Index, F101_Index(1501) is identified and located using a Location_Tag and each location tag is encoded with 3PL Item Response Functions and PIRI INTELLIGENT API (1512) processes the Item Response Method chosen.

The sub Money Index, F102_Index(1502) is identified and located using a Location_Tag and each location tag is encoded with 3PL Item Response Functions and PIRI INTELLIGENT API (1512) processes the Item Response Method chosen.

The sub Money Index, F103_Index(1503) is identified and located using a Location_Tag and each location tag is encoded with 3PL Item Response Functions and PIRI INTELLIGENT API (1512) processes the Item Response Method chosen.

The sub Money Index, F104_Index(1504) is identified and located using a Location_Tag and each location tag is encoded with 3PL Item Response Functions and PIRI INTELLIGENT API (1512) processes the Item Response Method chosen.

The sub Money Index, F105_Index(1505) is identified and located using a Location_Tag and each location tag is encoded with 3PL Item Response Functions and PIRI INTELLIGENT API (1512) processes the Item Response Method chosen.

The sub Money Index, F106_Index(1506) is identified and located using a Location_Tag and each location tag is encoded with 3PL Item Response Functions and PIRI INTELLIGENT API (1512) processes the Item Response Method chosen.

The sub Money Index, F107_Index(1507) is identified and located using a Location_Tag and each location tag is encoded with 3PL Item Response Functions and PIRI INTELLIGENT API (1612) processes the Item Response Method chosen.

The sub Money Index, F108_Index(1508) is identified and located using a Location_Tag and each location tag is encoded with 3PL Item Response Functions and PIRI INTELLIGENT API (1612) processes the Item Response Method chosen.

The Dynamic Lifestyle Index (1609) is a category within the Dynamic Content Distribution System that is used to distribute dynamic Lifestyle content based on the user psychometric and socio-demographic attributes to the user's via a Content Management System—CMS—(1610). When the User clicks—select—content the interaction is tracked using Item Response Functions (1611) that are processed by the PIRI INTELLIGENT API (1612).

The sub Lifestyle Index, L100_Index(1600) is identified and located using a Location_Tag and each location tag is encoded with 3PL Item Response Functions and PIRI INTELLIGENT API (1612) processes the Item Response Method chosen.

The sub Lifestyle Index, L101_Index(1601) is identified and located using a Location_Tag and each location tag is encoded with 3PL Item Response Functions and PIRI INTELLIGENT API (1612) processes the Item Response Method chosen.

The sub Lifestyle Index, L102_Index(1602) is identified and located using a Location_Tag and each location tag is encoded with 3PL Item Response Functions and PIRI INTELLIGENT API (1612) processes the Item Response Method chosen.

The sub Lifestyle Index, L103_Index(1603) is identified and located using a Location_Tag and each location tag is encoded with 3PL Item Response Functions and PIRI INTELLIGENT API (1612) processes the Item Response Method chosen.

The sub Lifestyle Index, L104_Index(1604) is identified and located using a Location_Tag and each location tag is encoded with 3PL Item Response Functions and PIRI INTELLIGENT API (1612) processes the Item Response Method chosen.

The sub Lifestyle Index, L105_Index(1605) is identified and located using a Location_Tag and each location tag is encoded with 3PL Item Response Functions and PIRI INTELLIGENT API (1612) processes the Item Response Method chosen.

The sub Lifestyle Index, L106_Index(1606) is identified and located using a Location_Tag and each location tag is encoded with 3PL Item Response Functions and PIRI INTELLIGENT API (1612) processes the Item Response Method chosen.

The sub Lifestyle Index, L107_Index(1607) is identified and located using a Location_Tag and each location tag is encoded with 3PL Item Response Functions and PIRI INTELLIGENT API (1612) processes the Item Response Method chosen.

The sub Lifestyle Index, L108_Index(1608) is identified and located using a Location_Tag and each location tag is encoded with 3PL Item Response Functions and PIRI INTELLIGENT API (1612) processes the Item Response Method chosen.

The Dynamic Music Index (1709) is a category within the Dynamic Content Distribution System that is used to distribute dynamic Music content based on the user psychometric and socio-demographic attributes to the user's via a Content Management System—CMS—(1710). When the User clicks—select—content the interaction is tracked using Item Response Functions (1711) that are processed by the PIRI INTELLIGENT API (1712).

The sub Music Index, M100_Index(1700) is identified and located using a Location_Tag and each location tag is encoded with 3PL Item Response Functions and PIRI INTELLIGENT API (1712) processes the Item Response Method chosen.

The sub Music Index, M101_Index(1701) is identified and located using a Location_Tag and each location tag is encoded with 3PL Item Response Functions and PIRI INTELLIGENT API (1712) processes the Item Response Method chosen.

The sub Music Index, M102_Index(1702) is identified and located using a Location_Tag and each location tag is encoded with 3PL Item Response Functions and PIRI INTELLIGENT API (1712) processes the Item Response Method chosen.

The sub Music Index, M103_Index(1703) is identified and located using a Location_Tag and each location tag is encoded with 3PL Item Response Functions and PIRI INTELLIGENT API (1712) processes the Item Response Method chosen.

The sub Music Index, M104_Index(1704) is identified and located using a Location_Tag and each location tag is encoded with 3PL Item Response Functions and PIRI INTELLIGENT API (1712) processes the Item Response Method chosen.

The sub Music Index, M105_Index(1705) is identified and located using a Location_Tag and each location tag is encoded with 3PL Item Response Functions and PIRI INTELLIGENT API (1712) processes the Item Response Method chosen.

The sub Music Index, M106_Index(1706) is identified and located using a Location_Tag and each location tag is encoded with 3PL Item Response Functions and PIRI INTELLIGENT API (1712) processes the Item Response Method chosen.

The sub Music Index, M107_Index(1707) is identified and located using a Location_Tag and each location tag is encoded with 3PL Item Response Functions and PIRI INTELLIGENT API (1712) processes the Item Response Method chosen.

The sub Music Index, M108_Index(1708) is identified and located using a Location_Tag and each location tag is encoded with 3PL Item Response Functions and PIRI INTELLIGENT API (1712) processes the Item Response Method chosen.

The Dynamic Movies Index (1809) is a category within the Dynamic Content Distribution System that is used to distribute dynamic Movies content based on the user psychometric and socio-demographic attributes to the user's via a Content Management System—CMS—(1810). When the User clicks—select—content the interaction is tracked using Item Response Functions (1811) that are processed by the PIRI INTELLIGENT API (1812).

The sub Movies Index, H100_Index(1800) is identified and located using a Location_Tag and each location tag is encoded with 3PL Item Response Functions and PIRI INTELLIGENT API (1812) processes the Item Response Method chosen.

The sub Movies Index, H101_Index(1801) is identified and located using a Location_Tag and each location tag is encoded with 3PL Item Response Functions and PIRI INTELLIGENT API (1812) processes the Item Response Method chosen.

The sub Movies Index, H102_Index(1802) is identified and located using a Location_Tag and each location tag is encoded with 3PL Item Response Functions and PIRI INTELLIGENT API (1812) processes the Item Response Method chosen.

The sub Movies Index, H103_Index(1803) is identified and located using a Location_Tag and each location tag is encoded with 3PL Item Response Functions and PIRI INTELLIGENT API (1812) processes the Item Response Method chosen.

The sub Movies Index, H104_Index(1804) is identified and located using a Location_Tag and each location tag is encoded with 3PL Item Response Functions and PIRI INTELLIGENT API (1812) processes the Item Response Method chosen.

The sub Movies Index, H105_Index(1805) is identified and located using a Location_Tag and each location tag is encoded with 3PL Item Response Functions and PIRI INTELLIGENT API (1812) processes the Item Response Method chosen.

The sub Movies Index, H106_Index(1806) is identified and located using a Location_Tag and each location tag is encoded with 3PL Item Response Functions and PIRI INTELLIGENT API (1812) processes the Item Response Method chosen.

The sub Movies Index, H107_Index(1807) is identified and located using a Location_Tag and each location tag is encoded with 3PL Item Response Functions and PIRI INTELLIGENT API (1812) processes the Item Response Method chosen.

The sub Movies Index, H108_Index(1808) is identified and located using a Location_Tag and each location tag is encoded with 3PL Item Response Functions and PIRI INTELLIGENT API (1812) processes the Item Response Method chosen.

The Dynamic Local Index (1909) is a category within the Dynamic Content Distribution System that is used to distribute dynamic Local content based on the user psychometric and socio-demographic attributes to the user's via a Content Management System—CMS—(1910). When the User clicks—select—content the interaction is tracked using Item Response Functions (1911) that are processed by the PIRI INTELLIGENT API (1912).

The sub Local Index, R100_Index(1900) is identified and located using a Location_Tag and each location tag is encoded with 3PL Item Response Functions and PIRI INTELLIGENT API (1912) processes the Item Response Method chosen.

The sub Local Index, R101_Index(1901) is identified and located using a Location_Tag and each location tag is encoded with 3PL Item Response Functions and PIRI INTELLIGENT API (1912) processes the Item Response Method chosen.

The sub Local Index, R102_Index(1902) is identified and located using a Location_Tag and each location tag is encoded with 3PL Item Response Functions and PIRI INTELLIGENT API (1912) processes the Item Response Method chosen.

The sub Local Index, R103_Index(1903) is identified and located using a Location_Tag and each location tag is encoded with 3PL Item Response Functions and PIRI INTELLIGENT API (1912) processes the Item Response Method chosen.

The sub Local Index, R104_Index(1904) is identified and located using a Location_Tag and each location tag is encoded with 3PL Item Response Functions and PIRI INTELLIGENT API (1912) processes the Item Response Method chosen.

The sub Local Index, R105_Index(1905) is identified and located using a Location_Tag and each location tag is encoded with 3PL Item Response Functions and PIRI INTELLIGENT API (1912) processes the Item Response Method chosen.

The sub Local Index, R106_Index(1906) is identified and located using a Location_Tag and each location tag is encoded with 3PL Item Response Functions and PIRI INTELLIGENT API (2012) processes the Item Response Method chosen.

The sub Local Index, R107_Index(1907) is identified and located using a Location_Tag and each location tag is encoded with 3PL Item Response Functions and PIRI INTELLIGENT API (1912) processes the Item Response Method chosen.

The sub Local Index, R108_Index(1908) is identified and located using a Location_Tag and each location tag is encoded with 3PL Item Response Functions and PIRI INTELLIGENT API (1912) processes the Item Response Method chosen.

The Dynamic Cloud Index (2009) is a category within the Dynamic Content Distribution System that is used to distribute dynamic Cloud content based on the user psychometric and socio-demographic attributes to the user's via a Content Management System—CMS—(2010). When the User clicks—select—content the interaction is tracked using Item Response Functions (2011) that are processed by the PIRI INTELLIGENT API (2012).

The sub Cloud Index, CLD100_Index(2000) is identified and located using a Location_Tag and each location tag is encoded with 3PL Item Response Functions and PIRI INTELLIGENT API (2012) processes the Item Response Method chosen.

The sub Cloud Index, CLD101_Index(2001) is identified and located using a Location_Tag and each location tag is encoded with 3PL Item Response Functions and PIRI INTELLIGENT API (2012) processes the Item Response Method chosen.

The sub Cloud Index, CLD102_Index(2002) is identified and located using a Location_Tag and each location tag is encoded with 3PL Item Response Functions and PIRI INTELLIGENT API (2012) processes the Item Response Method chosen.

The sub Cloud Index, CLD103_Index(2003) is identified and located using a Location_Tag and each location tag is encoded with 3PL Item Response Functions and PIRI INTELLIGENT API (2012) processes the Item Response Method chosen.

The sub Cloud Index, CLD104_Index(2004) is identified and located using a Location_Tag and each location tag is encoded with 3PL Item Response Functions and PIRI INTELLIGENT API (2012) processes the Item Response Method chosen.

The sub Cloud Index, CLD105_Index 2005) is identified and located using a Location_Tag and each location tag is encoded with 3PL Item Response Functions and PIRI INTELLIGENT API (2012) processes the Item Response Method chosen.

The sub Cloud Index, CLD106_Index(2006) is identified and located using a Location_Tag and each location tag is encoded with 3PL Item Response Functions and PIRI INTELLIGENT API (2012) processes the Item Response Method chosen.

The sub Cloud Index, CLD107_Index(2007) is identified and located using a Location_Tag and each location tag is encoded with 3PL Item Response Functions and PIRI INTELLIGENT API (2012) processes the Item Response Method chosen.

The sub Cloud Index, CLD108_Index(2008) is identified and located using a Location_Tag and each location tag is encoded with 3PL Item Response Functions and PIRI INTELLIGENT API (2012) processes the Item Response Method chosen.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A dynamic content distribution method wherein an item response function (IRF) is used to suggest content to end-users based on psychometric reasoning;
wherein the content is provided by a relational database management system which stores content and the content is categorized according to psychometric attributes according to predetermined psychological measurement categories; and
wherein the categories include the measure of knowledge, abilities, attitudes, and personality traits.

2. The dynamic content distribution method of claim 1 wherein the content suggested relates to news.

3. The dynamic content distribution method of claim 1 wherein the content suggested relates to entertainment.

4. The dynamic content distribution method of claim 1 wherein the content suggested relates to sports.

5. The dynamic content distribution method of claim 1 wherein the content suggested relates to money and finance.

6. The dynamic content distribution method of claim 1 wherein the content suggested relates to lifestyle.

7. The dynamic content distribution method of claim 1 wherein the content suggested relates to music.

8. The dynamic content distribution method of claim 1 wherein the content suggested relates to movies.

9. The dynamic content distribution method of claim 1 wherein the content suggested relates to local and regional events and information.

10. The dynamic content distribution method of claim 1 wherein the IRF is used to measure and deliver content based on the user's Personality Attributes as well as to deliver content based on a comparison to the Personality Attributes of other users.

11. The dynamic content distribution method of claim 1 wherein the IRF is used to measure and deliver content based on the user's Abstract Reasoning Attributes as well as to deliver content based on a comparison to the Abstract Reasoning Attributes of other users.

12. The dynamic content distribution method of claim 1 wherein the IRF is used to measure and deliver content based on the user's Numerical Reasoning Attributes as well as to deliver content based on a comparison to the Numerical Reasoning Attributes of other users.

13. The dynamic content distribution method of claim 1 wherein the IRF is used to measure and deliver content based on the user's Verbal Reasoning Attributes as well as to deliver content based on a comparison to the Verbal Reasoning Attributes of other users.

14. The dynamic content distribution method of claim 1 wherein the IRF is used to measure and deliver content based on the user's Computer Skill Set Attributes as well as to deliver content based on a comparison to the Computer Skill Set Attributes of other users.

15. The dynamic content distribution method of claim 1 wherein the IRF is used to measure and deliver content based on the user's Emotional Quotient Attributes as well as to deliver content based on a comparison to the Emotional Quotient Attributes of other users.

16. The dynamic content distribution method of claim 1 wherein the IRF is used to measure and deliver content based on the user's Mechanical Reasoning Attributes as well as to deliver content based on a comparison to the Mechanical Reasoning Attributes of other users.

17. The dynamic content distribution method of claim 1 wherein the IRF is used to measure and deliver content based on the user's Cognitive Reasoning Attributes as well as to deliver content based on a comparison to the Cognitive Reasoning Attributes of other users.

18. The dynamic content distribution method of claim 1 wherein the IRF is used to measure and deliver content based on the user's Intelligent Quotient Attributes as well as to deliver content based on a comparison to the Intelligent Quotient Attributes of other users.

19. The dynamic content distribution method of claim 1 wherein the IRF is used to measure and deliver content based on the user's Spatial Ability Attributes as well as to deliver content based on a comparison to the Spatial Ability Attributes of other users.

20. A dynamic content distribution method wherein an item response function (IRF) is used to suggest content from cloud applications to end-users based on psychometric reasoning;
wherein the content is provided by a relational database management system which stores content and the content is categorized according to psychometric attributes according to predetermined psychological measurement categories; and
wherein the categories include the measure of knowledge, abilities, attitudes, and personality traits.

21. The dynamic content distribution method of claim 1 wherein the IRF is selected from a group of functions including: a test information function (TIF), an item information function (IIF), a standard error management function (SEM), and an ability estimation model function (AEM).

22. The dynamic content distribution method of claim 2 wherein the IRF is selected from a group of functions including: a test information function (TIF), an item information function (IIF), a standard error management function (SEM), and an ability estimation model function (AEM).

23. The dynamic content distribution method of claim 3 wherein the IRF is selected from a group of functions including: a test information function (TIF), an item information function (IIF), a standard error management function (SEM), and an ability estimation model function (AEM).

24. The dynamic content distribution method of claim 4 wherein the IRF is selected from a group of functions including: a test information function (TIF), an item information function (IIF), a standard error management function (SEM), and an ability estimation model function (AEM).

25. The dynamic content distribution method of claim 5 wherein the IRF is selected from a group of functions including: a test information function (TIF), an item information function (IIF), a standard error management function (SEM), and an ability estimation model function (AEM).

26. The dynamic content distribution method of claim 6 wherein the IRF is selected from a group of functions including: a test information function (TIF), an item information function (IIF), a standard error management function (SEM), and an ability estimation model function (AEM).

27. The dynamic content distribution method of claim 7 wherein the IRF is selected from a group of functions including: a test information function (TIF), an item information function (IIF), a standard error management function (SEM), and an ability estimation model function (AEM).

28. The dynamic content distribution method of claim 8 wherein the IRF is selected from a group of functions including: a test information function (TIF), an item information function (IIF), a standard error management function (SEM), and an ability estimation model function (AEM).

29. The dynamic content distribution method of claim 9 wherein the IRF is selected from a group of functions including: a test information function (TIF), an item information function (IIF), a standard error management function (SEM), and an ability estimation model function (AEM).

30. The dynamic content distribution method of claim wherein the IRF is selected from a group of functions including: a test information function (TIF), an item information function (IIF), a standard error management function (SEM), and an ability estimation model function (AEM).

31. The dynamic content distribution method of claim 11 wherein the IRF is selected from a group of functions including: a test information function (TIF), an item information function (IIF), a standard error management function (SEM), and an ability estimation model function (AEM).

32. The dynamic content distribution method of claim 12 wherein the IRF is selected from a group of functions including: a test information function (TIF), an item information function (IIF), a standard error management function (SEM), and an ability estimation model function (AEM).

33. The dynamic content distribution method of claim 13 wherein the IRF is selected from a group of functions including: a test information function (TIF), an item information function (IIF), a standard error management function (SEM), and an ability estimation model function (AEM).

34. The dynamic content distribution method of claim 14 wherein the IRF is selected from a group of functions including: a test information function (TIF), an item information function (IIF), a standard error management function (SEM), and an ability estimation model function (AEM).

35. The dynamic content distribution method of claim 15 wherein the IRF is selected from a group of functions including: a test information function (TIF), an item information function (IIF), a standard error management function (SEM), and an ability estimation model function (AEM).

36. The dynamic content distribution method of claim 16 wherein the IRF is selected from a group of functions including: a test information function (TIF), an item information function (IIF), a standard error management function (SEM), and an ability estimation model function (AEM).

37. The dynamic content distribution method of claim 17 wherein the IRF is selected from a group of functions including: a test information function (TIF), an item information function (IIF), a standard error management function (SEM), and an ability estimation model function (AEM).

38. The dynamic content distribution method of claim 18 wherein the IRF is selected from a group of functions including: a test information function (TIF), an item information function (IIF), a standard error management function (SEM), and an ability estimation model function (AEM).

39. The dynamic content distribution method of claim 19 wherein the IRF is selected from a group of functions including: a test information function (TIF), an item information function (IIF), a standard error management function (SEM), and an ability estimation model function (AEM).

40. The dynamic content distribution method of claim 20 wherein the IRF is selected from a group of functions including: a test information function (TIF), an item information function (IIF), a standard error management function (SEM), and an ability estimation model function (AEM).
